(19) United States
(12) Patent Application Publication
(10) Pub. No.: US 2012/0138716 A1
(43) Pub. Date: Jun. 7, 2012

(54) AUTOMATIC BREAD MAKING MACHINE

(76) Inventors: Teruaki Taguchi, Tottori-shi (JP); Takashi Watanabe, Tottori-shi (JP); Yasuyuki Ito, Tottori-shi (JP); Kazuya Yano, Tottori-shi (JP)

(21) Appl. No.: 13/390,665

(22) PCT Filed: Aug. 24, 2010
(86) PCT No.: PCT/JP2010/064222

§ 371 Date: Feb. 15, 2012

(30) Foreign Application Priority Data
Aug. 25, 2009 (JP) 2009-194127
Dec. 9, 2009 (JP) 2009-279703
Jan. 27, 2010 (JP) 2010-015498
Jan. 27, 2010 (JP) 2010-015499

(51) Int. Cl. B02C 23/00

(52) U.S. Cl. 241/36

(57) ABSTRACT

An automatic bread making machine (1) according to the present invention includes: a bread container (50) into which bread-making ingredients are put; a baking chamber (40) which is provided within a main body (10) and which receives the bread container (50); a blade rotation shaft (52) which is provided in a bottom portion of the bread container (50); a grinding blade (54) which is attached to the blade rotation shaft (52) such that the grinding blade (54) cannot be rotated; a dome-shaped cover (70) which has a kneading blade (72) on an outer surface and which is attached to the blade rotation shaft (52) so as to cover the grinding blade (54); motors (60) and (64) which are provided within the main body (10) and which provides a rotation force to the blade rotation shaft (52); and a clutch (76) which switches whether to transmit the rotation force of the blade rotation shaft (52) to the cover (70).

### TECHNICAL FIELD

The present invention relates to automatic bread making machines that are mainly used in common households.

### BACKGROUND ART

In general, a commercially available automatic home bread making machine has the following mechanism: a bread container where bread-making ingredients are placed is put into a baking chamber within a main body; the bread-making ingredients within the bread container are kneaded with a kneading blade and are squeezed; and, after a fermentation process, the bread is baked with the bread container used as a bread baking mold. Patent document 1 discloses an example of the automatic bread making machine.

An optional ingredient such as raisins or nuts is mixed with bread-making ingredients, and thus optional ingredient-containing bread is often baked. Patent document 2 discloses an automatic bread making machine that has means for automatically putting a secondary bread-making material such as raisins, nuts or cheese.

### RELATED ART DOCUMENT

### Patent Document

Patent document 1: JP-A-2000-116526
Patent document 2: Japanese Patent No. 3191645

### DISCLOSURE OF THE INVENTION

### Problems to be Solved by the Invention

At the time of bread making, it has so far been necessary to first acquire either powder obtained by milling grain such as wheat or rice or a bread mix obtained by mixing the powder with various secondary ingredients. Even if cereal grains (typically rice grains) are available, it is difficult to make bread directly from them.

The present invention is made in view of the foregoing; an object of the present invention is to provide an automatic bread making machine that has a convenient mechanism for making bread directly from cereal grains and thus help easily achieve bread-making.

### Means for Solving the Problem

To achieve the above object, according to the present invention, there is provided an automatic bread making machine including: a bread container into which bread-making ingredients are put; a baking chamber which is provided within a main body and which receives the bread container; a blade rotation shaft which is provided in a bottom portion of the bread container; a grinding blade which is attached to the blade rotation shaft such that the grinding blade cannot be rotated; a dome-shaped cover which has a kneading blade on an outer surface and which is attached to the blade rotation shaft so as to cover the grinding blade; a motor which is provided within the main body and which provides a rotation force to the blade rotation shaft; and a clutch which switches whether to transmit the rotation force of the blade rotation shaft to the cover.

With this configuration, cereal grains are put into the bread container and are ground by the grinding blade, and thus it is possible to make the bread-making ingredients within the bread container. Thereafter, the bread-making ingredients are kneaded by the kneading blade, and furthermore fermentation and baking processes can be performed. The cereal grains ground within the bread container, as they are, can be baked into bread within the bread container. Hence, unlike a case where the cereal grains are ground within another container and are then transferred to the bread container, the problem does not occur in which the ground flour is left within the another container and is not shifted to the bread container, with the result that no loss is produced in the shifting. The grinding blade and the kneading blade may be kept in the bread container from the grinding of the cereal grains to the completion of the baking of the bread, and moreover, the grinding blade and the kneading blade can be selectively used only by switching the transmission of the rotation force of the blade rotation shaft by the clutch, with the result that the operation is easily performed. Furthermore, since the grinding blade grinds the cereal grains within the cover, the cereal grains are prevented from being dispersed from the bread container.

Preferably, in the automatic bread making machine configured as described above, the clutch intervenes between the blade rotation shaft and the cover, and the clutch couples, when the blade rotation shaft is rotated in one direction, the blade rotation shaft to the cover whereas the clutch disconnects, when the blade rotation shaft is rotated in an opposite direction from the one direction, the coupling between the blade rotation shaft and the cover.

Since, with this configuration, the direction of rotation of the blade rotation shaft is only reversed and thus it is possible to selectively use the grinding blade and the kneading blade, the operation is easily performed.

In the automatic bread making machine configured as described above, the kneading blade may be attached to the cover such that the position of the kneading blade can be changed, and the clutch may switch the coupling state between the blade rotation shaft and the cover according to the position of the kneading blade. Alternatively, in a specific example of the configuration of this case, the kneading blade is provided on the cover such that the kneading blade can be rotated, and is attached to take two positions which are a folded position and an open position, and when the blade rotation shaft is rotated in the one direction, the kneading blade is brought into the folded position and the clutch couples the blade rotation shaft to the cover whereas, when the blade rotation shaft is rotated in the opposite direction, the kneading blade is brought into the open position to make contact with an inner wall of the bread container and prevent the rotation of the cover, and the clutch disconnects the coupling between the blade rotation shaft and the cover.

In this configuration, since, when the grinding blade performs grinding, the kneading blade makes contact with the inner wall of the bread container and thus the rotation of itself and the cover is stopped, the mixture of the cereal grains and the liquid is prevented from spilling out of the bread container as a result of the mixture swirling within the bread container. When the coupling of the blade rotation shaft and the cover is required, the coupling is reliably performed whereas, when the disconnection of the coupling between the blade rotation shaft and the cover is required, the coupling is reliably disconnected.

Alternatively, in the above specific example of the configuration, the kneading blade is attached by a pivot shaft supporting it to the cover such that the kneading blade can be rotated; and the value of the radius of rotation from the center of the pivot shaft to the end of the kneading blade is set such that, when the blade rotation shaft is rotated in the opposite direction, and the kneading blade in the incomplete open position makes contact with the inner wall of the bread container, the kneading blade in the incomplete open position can pass around the area of contact with the inner wall of the bread container. Thus, when the cereal grains are ground, the rotation system is not stopped, with the result that the motor is prevented from burning.

In the above specific example of the configuration, a complementary kneading blade which is aligned with the kneading blade that is in the folded position may be formed on the cover. In this configuration, when the kneading blade is in the folded position, the complementary kneading blade is aligned in the direction in which the kneading blade extends, and it appears as if the shape of the angle bracket of the kneading blade is increased in size. Thus, it is possible to reliably perform the kneading by forcing the dough material.

Alternatively, in the above specific example of the configuration, the clutch is formed with a first engagement member which is attached to the blade rotation shaft such that the first engagement member cannot be rotated and a second engagement member that is attached to a pivot shaft such that the second engagement member cannot be rotated, and the pivot shaft is arranged at a location away from the blade rotation shaft and moves together with the kneading blade, and the second engagement member interferes, when the kneading blade is brought into the folded position, with a rotational orbit of the first engagement member whereas the second engagement member retracts, when the kneading blade is brought into the open position, from the rotational orbit of the first engagement member.

With this configuration, it is possible to form the clutch that has a simple configuration and performs a reliable operation. Since the configuration is simple, the cleaning is easy.

In the automatic bread making machine configured as described above, a control device may be included which controls the rotation of the blade rotation shaft, and, at an early stage of the rotation of the blade rotation shaft, the control device may rotate the blade rotation shaft either at a speed lower than a rated rotation speed or intermittently.

In this configuration, since, at an early stage of the rotation of the blade rotation shaft, the control device rotates the blade rotation shaft either at a speed lower than the rated rotation speed or intermittently, the kneading blade and the grinding blade are moved slowly at an early stage, with the result that the cereal grains, the liquid, the dough material that is the mixture of the ground cereal grains and the liquid and the like are not dispersed from the bread container. Noise and vibrations accompanied by the movement at the early stage can be reduced to low levels. Mechanical components such as the clutch are also prevented from being damaged.

In the automatic bread making machine configured as described above, the low speed rotation or the intermittent rotation is preferably continued for a predetermined period of time.

With this configuration, it is possible to reliably and softly couple the blade rotation shaft to a member driven by the blade rotation shaft.

In the automatic bread making machine configured as described above, a heat insulation layer may be provided on one or both of surfaces of the blade rotation shaft and a blade rotation shaft reception portion of the cover.

Preferably, either the kneading blade that kneads the bread dough or its supporting member is removably attached to the blade rotation shaft that drives it. This is because a consideration is given to the fact that the kneading blade or its supporting member is removed from the bread container and is then cleaned. When this type of removable structure is employed, a gap exists between the blade rotation shaft and a portion receiving it. When the bread dough enters this gap, the bread dough is burned to solidify, that is, it is “burned and left.” When the dough is burned and left, it becomes difficult to remove the kneading blade or its supporting member, and this affects the removal of the baked bread, with the result that it is preferable to prevent, as much as possible, the dough from being burned and left. With respect to this point, since, in this configuration, the heat insulation layer is formed on one or both of the surfaces of the kneading blade supporting member (corresponding to the cover) of the blade rotation shaft and the blade rotation shaft reception portion of the kneading blade supporting member, even if the bread-making ingredients enter the gap between the fitting portion, they are unlikely to be burned and left, with the result that it is possible to easily remove the kneading blade supporting member from the blade rotation shaft.

In the above configuration, low friction coating may be applied to the surface on which the heat insulation layer is not formed, among the blade rotation shaft reception portion and the fitting portion of the blade rotation shaft to the blade rotation shaft reception portion. Thus, it is possible to more easily remove the kneading blade supporting member (corresponding to the cover) from the blade rotation shaft. Since the low friction coating makes contact with not the exposed metallic surface but the heat insulation layer, abrasion and peeling are unlikely to be encountered, and thus it is possible to maintain low friction for a long period of time.

In the automatic bread making machine configured as described above, a guard may be removably attached to the cover such that the guard covers a bottom surface of the cover to prevent access of a finger to the grinding blade.

In this configuration, since the bottom surface of the dome-shaped cover covering the grinding blade is covered by the guard, when the grinding blade and the cover are attached to the blade rotation shaft or are removed from the blade rotation shaft, or the grinding blade and the cover embedded in the bread are removed from the bread, a finger is prevented from being injured by touching the grinding blade. The guard is preferably formed of, for example, synthetic resin that is unlikely to transmit heat.

In the automatic bread making machine configured as described above, the guard may include a hub that the blade rotation shaft passes through and a plurality of spokes in which spaces between the spokes are opening portions that cereal grains to be ground by the grinding blade pass through.

With this configuration, it is possible to easily obtain the guard that satisfies both requirements, that is, the acquisition of safety of a finger and the ease of the passing through of the cereal grains.

Preferably, in the automatic bread making machine configured as described above, the clutch intervenes between the blade rotation shaft and the cover, and the clutch couples, when the blade rotation shaft is rotated in the one direction, the blade rotation shaft to the cover whereas the clutch disconnects, when the blade rotation shaft is rotated in the opposite direction from the one direction, the coupling between the blade rotation shaft and the cover, and the spokes are shaped such that, when the guard is rotated in the one direction, the side of a center of the guard moves ahead, and the side of an outer edge of the guard moves behind.

With this configuration, it is possible to reduce the proportion of the dough that is discarded when the cover is removed from the baked bread because the dough material inside and outside the cover is forced out by the spokes at the time of the kneading.

In the automatic bread making machine configured as described above, when the spokes of the guard are attached to the cover, the spokes are preferably close to the grinding blade.

In this configuration, when the grinding blade grinds the cereal grains, since the guard and the grinding blade function like an outside blade and an inside blade of a rotary electric shaver, respectively, and the cereal grains are sheared between the spokes and the grinding blade, the grinding function is enhanced.

Alternatively, in the automatic bread making machine configured as described above, the clutch intervenes between the blade rotation shaft and the cover, and the clutch couples, when the blade rotation shaft is rotated in the one direction, the blade rotation shaft to the cover whereas the clutch disconnects, when the blade rotation shaft is rotated in the opposite direction from the one direction, the coupling between the blade rotation shaft and the cover, and a plurality of posts which surround the cover are formed on an outer edge of the guard such that the posts are arranged at a predetermined angle with respect to each other, and side surfaces of the posts that are front surfaces in the direction of rotation when the guard is rotated in the one direction are inclined upward.

In this configuration, when the kneading is performed, the dough material around the cover is sprung up by the front surface of the posts and is combined with the body of the dough material arranged above. Thus, it is possible to reduce the amount of the dough that is discarded because it is not combined as part of the bread.

Alternatively, in the automatic bread making machine configured as described above, the guard includes a hub that the blade rotation shaft passes through and a plurality of spokes in which spaces between the spokes are opening portions that cereal grains to be ground by the grinding blade pass through, and lower ends of the posts protrude downward beyond the spokes.

In this configuration, when the guard is placed on the placement surface of a table or the like, the spokes are raised off the placement surface and thus a space for air circulation is formed under the spokes. Hence, when it is desirable to cool the guard itself or the cover and the grinding blade that are supported by the guard, it is possible to cool them rapidly.

Alternatively, in the automatic bread making machine configured as described above, the guard is attached by forming bayonet coupling between the posts and the cover, and a direction in which the guard is turned when the guard is attached coincides with the opposite direction of the rotation of the blade rotation shaft.

With this configuration, it is possible to simply attach the guard to the cover. When the kneading is performed, the guard is prevented from being disconnected from the cover.

### ADVANTAGES OF THE INVENTION

According to the present invention, bread can be baked with cereal grains on hand, and thus it is unnecessary to buy cereal powder. In the case of rice, bread can be baked with rice having the desired degree of grain cleaning ranging from brown rice to white rice. Since processes from the grinding of the cereal grains to the baking of the bread can be performed consistently within the bread container within the baking chamber, there is little danger of the dough material being contaminated with foreign material. Furthermore, unlike a case where the cereal grains are ground within another container and are then transferred to the bread container, the problem in which the ground cereal gains are adhered to the another container and are left therewithin, that is, a loss accompanied by the shifting is not produced. The grinding blade and the kneading blade can be kept in the bread container from the beginning to the end, and thus they are easy to handle; moreover, the grinding can be performed without the cereal grains being dispersed from the bread container. Since, at an early stage of the rotation, the blade rotation shaft is rotated either at a speed lower than the rated rotation speed or intermittently, the kneading blade and the grinding blade are moved slowly at an early stage, with the result that the cereal grains, the liquid, the dough material that is the mixture of the ground cereal grains and the liquid and the like are not dispersed from the bread container. Noise and vibrations accompanied by the movement at the early stage can be reduced to low levels. Mechanical components are also prevented from being damaged.

### BRIEF DESCRIPTION OF DRAWINGS

FIG. 1 A vertical cross-sectional view of an automatic bread making machine according to a first embodiment of the present invention;

FIG. 2 A vertical cross-sectional view taken along a direction perpendicular to FIG. 1 in the automatic bread making machine of the first embodiment;

FIG. 3 A top view of a bread container when a kneading process is performed in the automatic bread making machine of the first embodiment;

FIG. 4 A top view of the bread container when a grinding process is performed in the automatic bread making machine of the first embodiment;

FIG. 5 A perspective view of a cover which is included in the automatic bread making machine of the first embodiment and to which a kneading blade is attached;

FIG. 6 A side view of the cover which is included in the automatic bread making machine of the first embodiment and to which the kneading blade is attached;

FIG. 7 A perspective view of the cover which is included in the automatic bread making machine of the first embodiment and to which the kneading blade is attached, when the cover is viewed from below;

FIG. 8 A bottom view of the cover which is included in the automatic bread making machine of the first embodiment and to which the kneading blade is attached;

FIG. 9 A bottom view of the cover in which the kneading blade is in an open position in the automatic bread making machine of the first embodiment;

FIG. 10 A control block diagram of the automatic bread making machine of the first embodiment;

FIG. 11 A vertical cross-sectional view of the bread container included in an automatic bread making machine of a second embodiment;

FIG. 12 A bottom view of the cover covered by a guard included in the automatic bread making machine of the second embodiment;

FIG. 13 A vertical cross-sectional view of the cover covered by the guard included in the automatic bread making machine of the second embodiment;

FIG. 14 A perspective view of the cover and the kneading blade included in the automatic bread making machine of the second embodiment, when they are viewed from above;

FIG. 15 A top view of the cover and the kneading blade included in the automatic bread making machine of the second embodiment;

FIG. 16 A perspective view of the cover and the kneading blade included in the automatic bread making machine of the second embodiment, when they are viewed from below;

FIG. 17 A bottom view of the cover and the kneading blade included in the automatic bread making machine of the second embodiment;

FIG. 18 A top view of the bread container when the grinding process is performed in the automatic bread making machine of the second embodiment;

FIG. 19 A top view of the bread container when the grinding process is performed, showing a different state from that of FIG. 18;

FIG. 20 A perspective view of the guard in the automatic bread making machine of the second embodiment;

FIG. 21 A side view of the guard in the automatic bread making machine of the second embodiment;

FIG. 22 A flowchart of the entire first bread making process;

FIG. 23 A flowchart of a pre-grinding soaking process in the first bread making process;

FIG. 24 A flowchart of a grinding process in the first bread making process;

FIG. 25 A flowchart of a kneading process in the first bread making process;

FIG. 26 A flowchart of a fermentation process in the first bread making process;

FIG. 27 A flowchart of a baking process in the first bread making process;

FIG. 28 A graph illustrating how a blade rotation shaft is rotated;

FIG. 29 A flowchart of the entire second bread making process;

FIG. 30 A flowchart of a post-grinding soaking process in the second bread making process;

FIG. 31 A flowchart of the entire third bread making process;

FIG. 32 A top view of the bread container illustrating a disadvantage produced when the present invention is not practiced, and corresponds to FIG. 18;

FIG. 33 A top view of the bread container illustrating a disadvantage produced when the present invention is not practiced, and corresponds to FIG. 19.

### BEST MODE FOR CARRYING OUT THE INVENTION

Embodiments of an automatic bread making machine according to the present invention will be described below with reference to accompanying drawings.

### Configuration of an Automatic Bread Making Machine

### 1. First embodiment

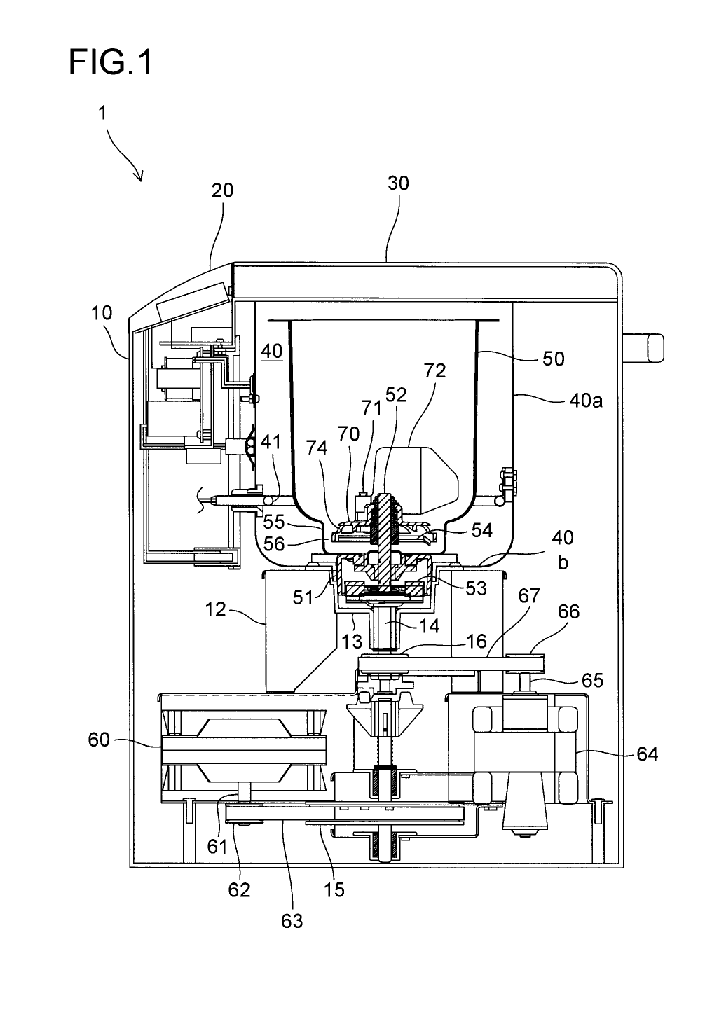

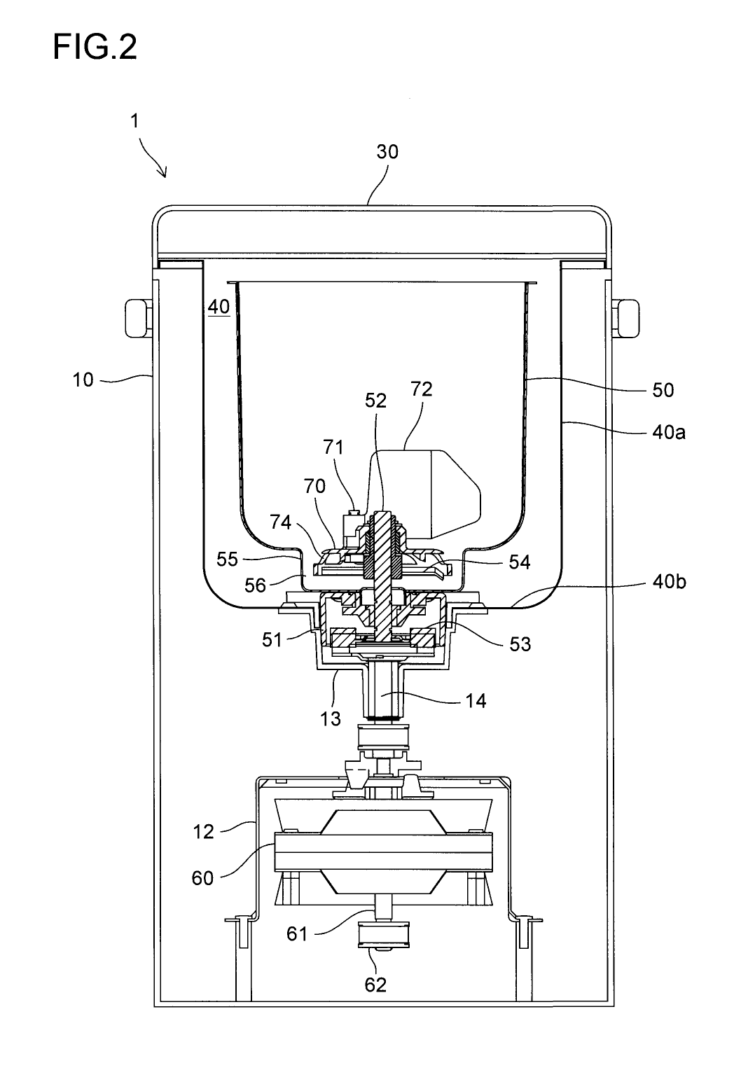

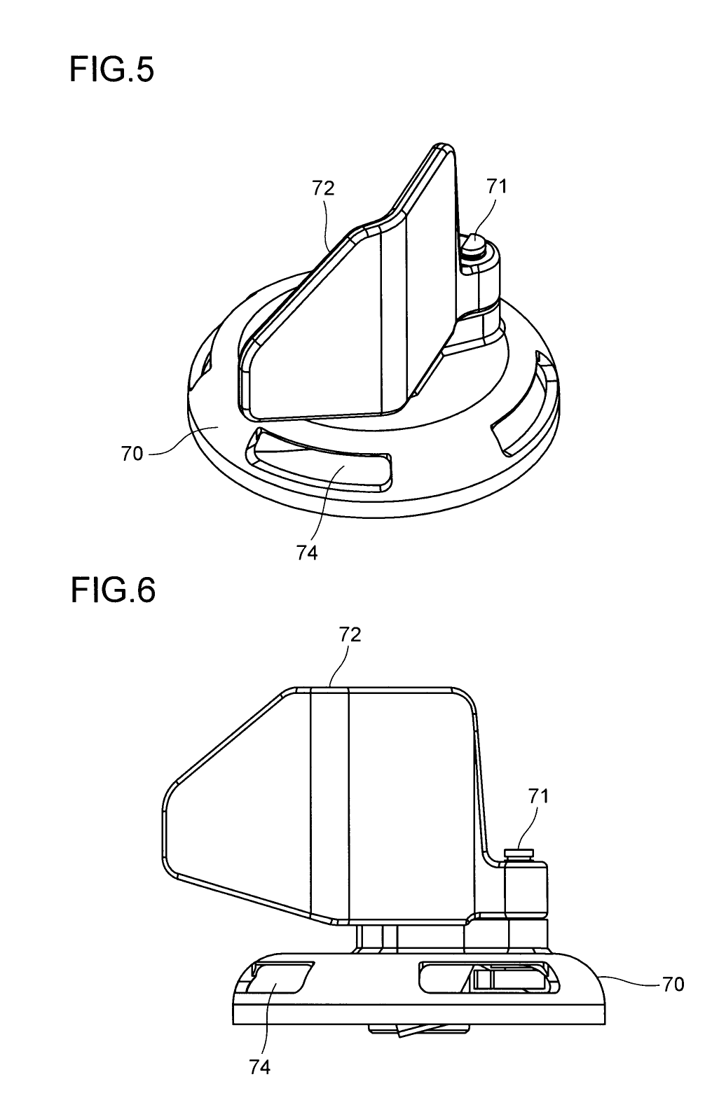

The configuration of an automatic bread making machine according to a first embodiment will first be described with reference to FIGS. 1 to 10. In FIG. 1, the left side of the figure is the side of the front face (front surface) of the automatic bread making machine 1, and the right side of the figure is the side of the back face (rear surface) of the automatic bread making machine 1. It is assumed that the side of the left hand of an observer opposite the front face of the automatic bread making machine 1 is the left side of the automatic bread making machine 1, and the side of the right hand is the right side of the automatic bread making machine 1.

The automatic bread making machine 1 has a main body 10 that is formed with a shell of synthetic resin and that is box-shaped. In a front portion of the upper surface of the main body 10, an operation portion 20 is provided. Although they are not shown, the operation portion 20 is provided with: a group of operation keys such as a selection key for the type of bread (such as flour bread, rice powder bread and optional ingredient-containing bread), a selection key for the type of cooking, a timer key, a start key and a deletion key; and a display portion that displays the type of cooking which has been set, a time which has been set with the timer and the like. The display portion is formed with a liquid crystal display panel and a display lamp in which a light-emitting diode is used as a light source.

The upper surface of the main body behind the operation portion 20 is covered with a lid 30 that is formed of synthetic resin. The lid 30 is attached, with an unillustrated hinge shaft, to the edge of the back face of the main body 10; the lid 30 is rotated on the hinge shaft within a vertical plane.

A baking chamber 40 is provided within the main body 10. The baking chamber 40 is formed of sheet metal; its upper surface is open, and a bread container 50 is put thereinto through the opening. The baking chamber 40 has a perimeter side wall 40a whose horizontal cross section is rectangular and a bottom wall 40b.

A base 12 formed of sheet metal is arranged within the main body 10. In the base 12, a bread container support portion 13 formed with a die casting of aluminum alloy is fixed at the center of the baking chamber 40. The interior of the bread container support portion 13 is exposed to the interior of the baking chamber 40.

A drive shaft 14 is vertically supported at the center of the bread container support portion 13. The rotation of the drive shaft 14 is provided by pulleys 15 and 16. A clutch is arranged between the pulley 15 and the drive shaft 14, and a clutch is arranged between the pulley 16 and the drive shaft 14. When the pulley 15 is rotated in one direction and thus the rotation is transmitted to the drive shaft 14, the rotation of the drive shaft 14 is not transmitted to the pulley 16 whereas, when the pulley 16 is rotated in the opposite direction to that of the pulley 15 and thus the rotation is transmitted to the drive shaft 14, the rotation of the drive shaft 14 is not transmitted to the pulley 15.

The pulley 15 is rotated by a kneading motor 60 that is supported by the base 12. The kneading motor 60 has a vertical shaft; the output shaft 61 protrudes from the lower surface. A pulley 62 that is coupled through a belt 63 to the pulley 15 is fixed to the output shaft 61. Since the kneading motor 60 itself operates at a low speed with a high torque, and moreover the pulley 62 causes the pulley 15 to rotate at a reduced speed, the drive shaft 14 is rotated at a low speed with a high torque.

The pulley 16 is likewise rotated by a grinding motor 64 that is supported by the base 12. The grinding motor 64 also has a vertical shaft; the output shaft 65 protrudes from the upper surface. A pulley 66 that is coupled through a belt 67 to the pulley 16 is fixed to the output shaft 65. The grinding motor 64 functions to provide high speed rotation to a grinding blade, which will be described later. Hence, as the grinding motor 64, a grinding motor of high speed rotation is selected, and a reduction speed ratio between the pulley 66 and the pulley 16 is set at a ratio of about 1:1.

The bread container support portion 13 receives a cylindrical base 51 fixed to the bottom surface of the bread container 50, and thereby supports the bread container 50. The base 51 is also a die casting of aluminum alloy. The bread container 50 and the base 51 may be molded separately and put together as described above; alternatively, they can be molded integrally by die casting.

The bread container 50 is formed of sheet metal and is shaped like a bucket; a handle (not shown) with which to carry the bread container 50 is attached to an edge portion of the bread container 50. A horizontal cross section of the bread container 50 has the shape of a rectangle with four curved corners. At the center of the bottom portion of the bread container 50, a vertical blade rotation shaft 52 that has been sealed is vertically supported. A rotation force is transmitted to the blade rotation shaft 52 through a coupling 53 from the drive shaft 14. The coupling 53 is composed of two members, one fixed to the bottom end of the blade rotation shaft 52 and the other fixed to the upper end of the drive shaft 14. The entire coupling 53 is enclosed by the base 51 and the bread container support portion 13.

On the inner perimeter surface of the bread container support portion 13 and the outer perimeter surface of the base 51, unillustrated protrusions are formed. These protrusions achieve known bayonet coupling. Specifically, when the bread container 50 is attached to the bread container support portion 13, the bread container 50 is lowered such that the protrusions of the base 51 do not interfere with those of the bread container support portion 13. Then, the base 51 is fitted into the bread container support portion 13, thereafter the bread container 50 is turned horizontally, and thus the protrusions of the base 51 engage with the bottom surfaces of the protrusions of the bread container support portion 13, with the result that the bread container 50 is prevented from being removed upwardly. This operation also achieves the coupling of the coupling 53 at the same time. The direction in which the bread container 50 is turned when the bread container 50 is attached is made to coincide with the direction in which the kneading blade, which will be described later, is rotated, and thus the bread container 50 is prevented from being removed even when the kneading blade is rotated.

A heating device 41 arranged within the baking chamber 40 surrounds the bread container 50 and heats bread-making ingredients. The heating device 41 is formed with a sheathed heater.

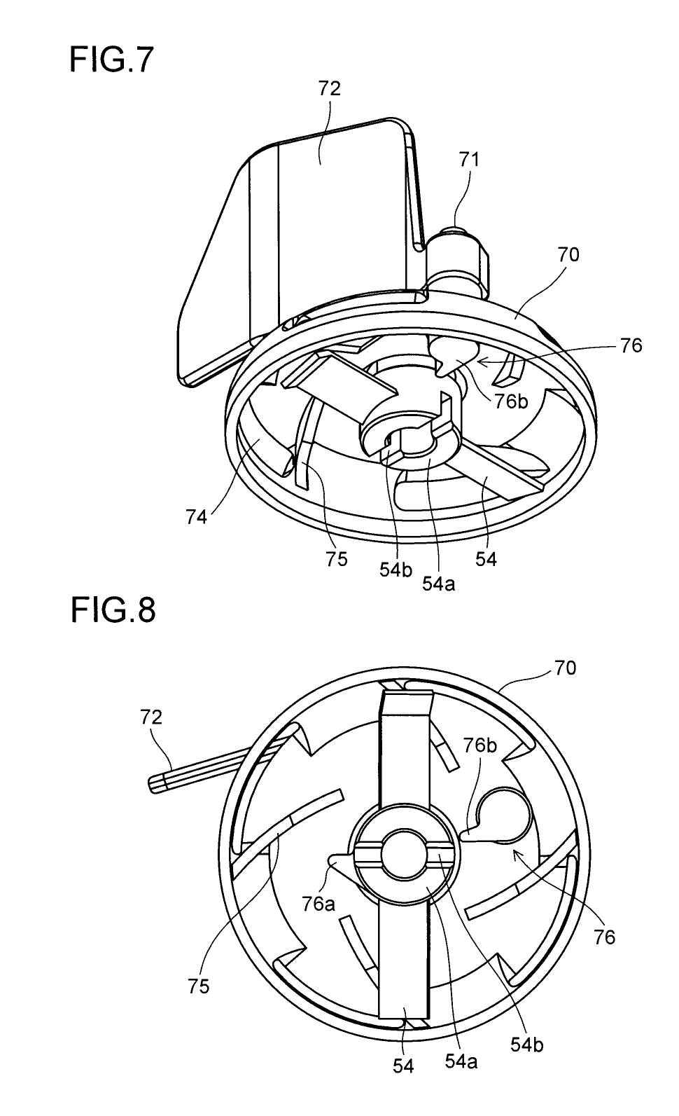

The grinding blade 54 is attached to the blade rotation shaft 52 at a portion slightly above the bottom surface of the bread container 50. The grinding blade 54 is prevented from being rotated with respect to the blade rotation shaft 52. The grinding blade 54 is formed with a stainless steel plate; as shown in FIGS. 7 and 8, the grinding blade 54 is shaped like a propeller of an airplane.

The center portion of the grinding blade 54 is formed into a hub 54a that fits to the blade rotation shaft 52. In the lower surface of the hub 54a, a groove 54b is formed to extend diametrically across the hub 54a. An unillustrated pin that horizontally passes through the blade rotation shaft 52 receives the hub 54a and engages with the groove 54b, and the grinding blade 54 is coupled to the blade rotation shaft 52 such that the grinding blade 54 cannot be rotated with respect to the blade rotation shaft 52. Since the grinding blade 54 can easily be pulled out of the blade rotation shaft 52, it is possible to perform cleaning after the completion of the bread-making operation and replace a blunt blade with ease.

A dome-shaped cover 70 whose shape is circular in plan view is attached to the upper end of the blade rotation shaft 52. The cover 70 is formed with a die casting of aluminum alloy, and covers the grinding blade 54. The cover 70 is rotatably fitted to the blade rotation shaft 52, and is received by the hub 54a of the grinding blade 54. Since the cover 70 can also easily be pulled out of the blade rotation shaft 52, it is possible to easily perform cleaning after the completion of the bread-making operation.

On the outer surface of the cover 70, the kneading blade 72 that is formed in the shape of an angle bracket in plan view is attached by a vertical pivot shaft 71 arranged at a location away from the blade rotation shaft 52. The kneading blade 72 is also a die casting of aluminum alloy. The pivot shaft 71 is either fixed to or formed integrally with the kneading blade 72, and moves together with the kneading blade 72.

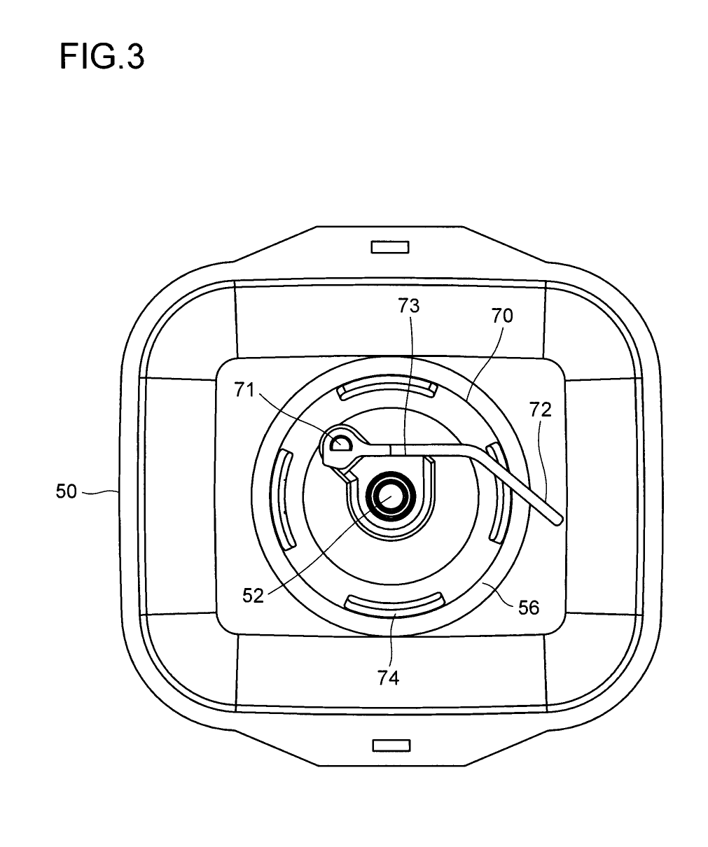

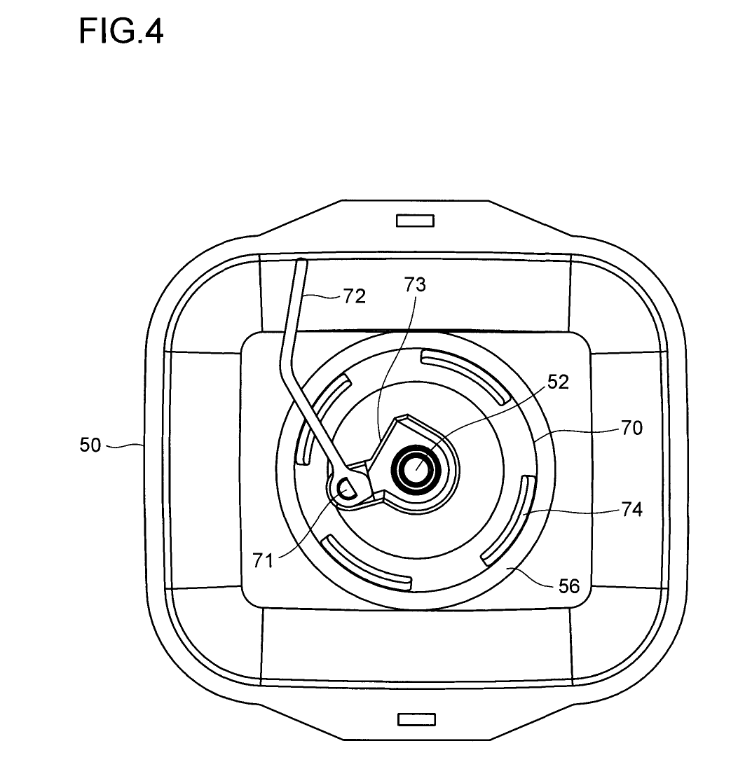

The kneading blade 72 is rotated on the pivot shaft 71 within a horizontal plane with respect to the cover 70, and takes two positions, that is, a folded position shown in FIG. 3 and an open position shown in FIG. 4. In the folded position, the kneading blade 72 makes contact with a stopper portion 73 formed on the cover 70, and thus cannot further be rotated clockwise with respect to the cover 70. Here, the end of the kneading blade 72 slightly protrudes from the cover 70. In the open position, the kneading blade 72 is located away from the stopper portion 73, and the end of the kneading blade 72 significantly protrudes from the cover 70.

In the cover 70, windows 74 by which a space within the cover and a space outside the cover communicate with each other are formed. The windows 74 are arranged at the same height as the grinding blade 53 or slightly above the grinding blade 53. In the embodiment, the total of the four windows 74 are arranged at an angle of 90° with respect to each other; instead, a number other than the above number and an angle other than the above angle in the arrangement can be selected.

As shown in FIGS. 7 and 8, the total of four ribs 75 corresponding to the windows 74 are formed on the inner surface of the cover 70. Each of the ribs 75 extends, obliquely with respect to the radial direction, from the vicinity of the center of the cover 70 to an outer circumferential ring-shaped wall; the four ribs are combined to form a four-comma shape. Each rib 75 is curved such that its side opposite the bread-making ingredients coming to the rib is convex. The grinding blade 54 is rotated so as to skim along the lower edges of the ribs 75.

A clutch 76 (see FIG. 8) intervenes between the cover 70 and the blade rotation shaft 52. The clutch 76 couples the blade rotation shaft 52 to the cover 70 in a rotation direction (the rotation in this direction is referred to as “forward direction rotation”) of the blade rotation shaft 52 when the kneading motor 60 rotates the drive shaft 14. On the other hand, the clutch 76 disconnects the coupling between the blade rotation shaft 52 and the cover 70 in a rotation direction (the rotation in this direction is referred to as “opposite direction rotation”) of the blade rotation shaft 52 when the grinding motor 64 rotates the drive shaft 14. In FIGS. 3 and 4, the “forward direction rotation” is counterclockwise rotation, and the “opposite direction rotation” is clockwise rotation.

The clutch 76 is formed with a first engagement member 76a and a second engagement member 76b. The first engagement member 76a is either fixed to or formed integrally with the hub 54a of the grinding blade 54, and thus the first engagement member 76a is attached such that the first engagement member 76a cannot be rotated with respect to the blade rotation shaft 52. The second engagement member 76b is either fixed to or formed integrally with the pivot shaft 71 of the kneading blade 72, and thus the angle is changed as the position of the kneading blade 72 is changed.

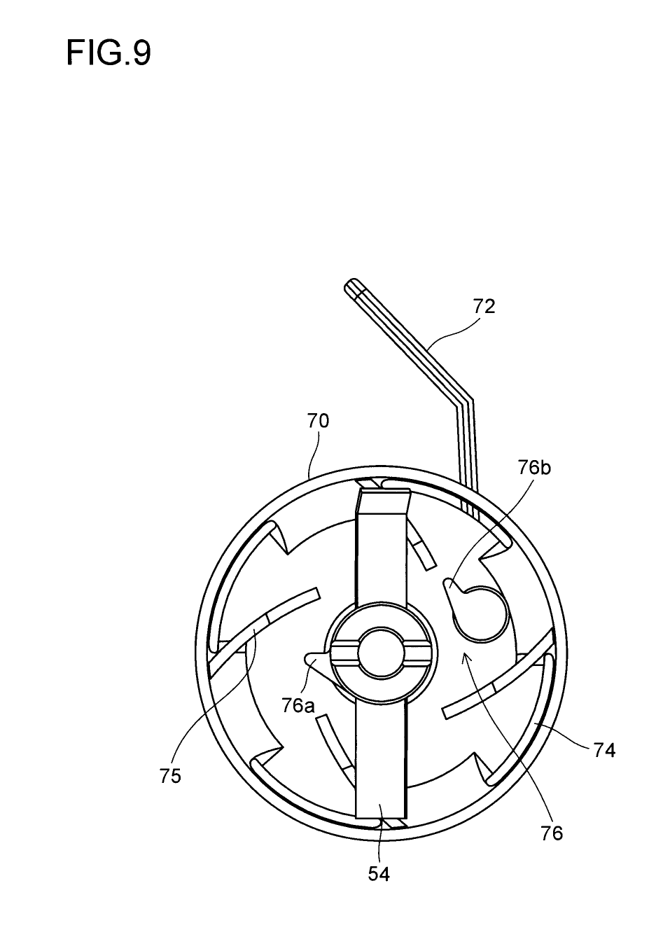

The clutch 76 changes the coupling state according to the position of the kneading blade 72. Specifically, when the kneading blade 72 is in the folded position shown in FIG. 3, the second engagement member 76b is arranged at an angle of FIG. 8. Here, the second engagement member 76b interferes with the rotational orbit of the first engagement member 76a; when the blade rotation shaft 52 is rotated clockwise in FIG. 8, that is, is rotated in the forward direction, the first engagement member 76a engages with the second engagement member 76b, with the result that the rotation force of the blade rotation shaft 52 is transmitted to the cover 70 and the kneading blade 72. When the kneading blade 72 is in the open position shown in FIG. 4, the second engagement member 76b is arranged at an angle of FIG. 9. Here, the second engagement member 76b retracts from the rotational orbit of the first engagement member 76a; even when the blade rotation shaft 52 is rotated counterclockwise in FIG. 9, that is, is rotated in the opposite direction, the first engagement member 76a does not engage with the second engagement member 76b. Therefore, the rotation force of the blade rotation shaft 52 is not transmitted to the cover 70 and the kneading blade 72.

In the bottom portion of the bread container 50, a concave portion 55 that accommodates the grinding blade 54 and the cover 70 is formed. The concave portion 55 is circular in plan view, and a gap 56 that allows the flow of the bread-making ingredients is formed between an outer circumferential portion of the cover 70 and the inner surface of the concave portion 55.

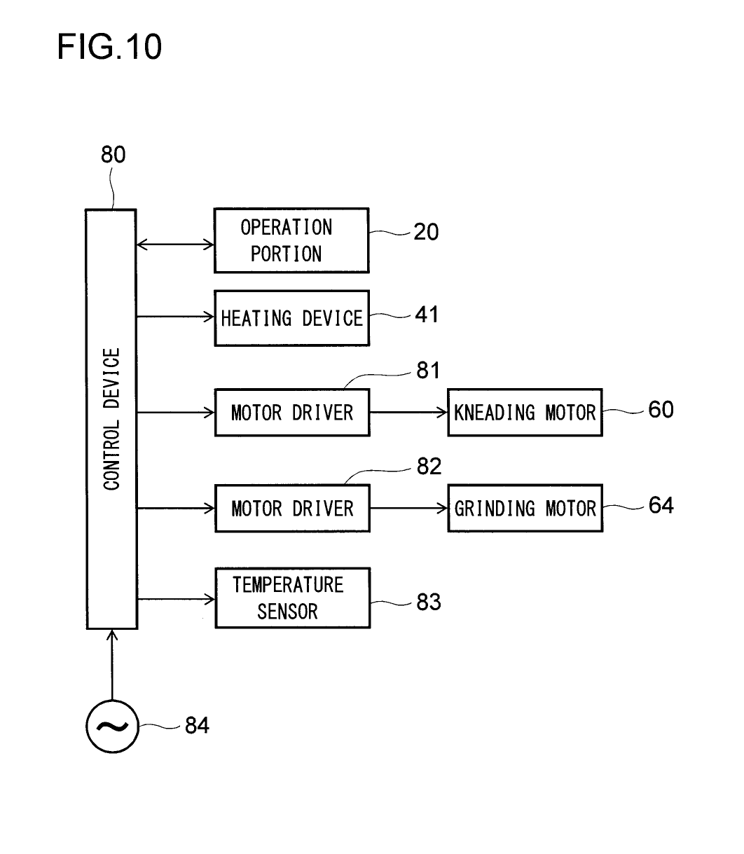

The operation of the automatic bread making machine 1 is controlled by a control device 80 shown in FIG. 10. The control device 80 is formed with a circuit board that is arranged at an appropriate portion (preferably a portion that is little affected by the heat of the baking chamber 40) within the main body 10; the operation portion 20, the heating device 41, a motor driver 81 of the kneading motor 60, a motor driver 82 of the grinding motor 64 and a temperature sensor 83 are connected to the control device 80. The temperature sensor 83 is arranged within the baking chamber 40, and detects the temperature of the baking chamber 40. Reference numeral 84 represents a commercial power supply that supplies power to the individual components.

### 2. Second Embodiment

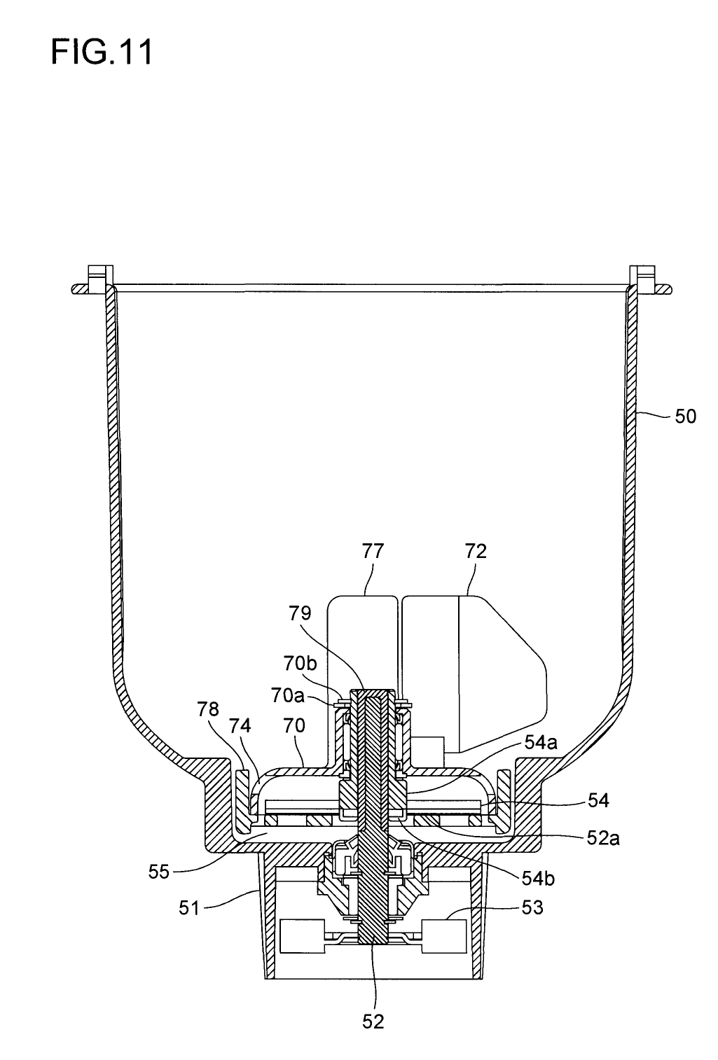

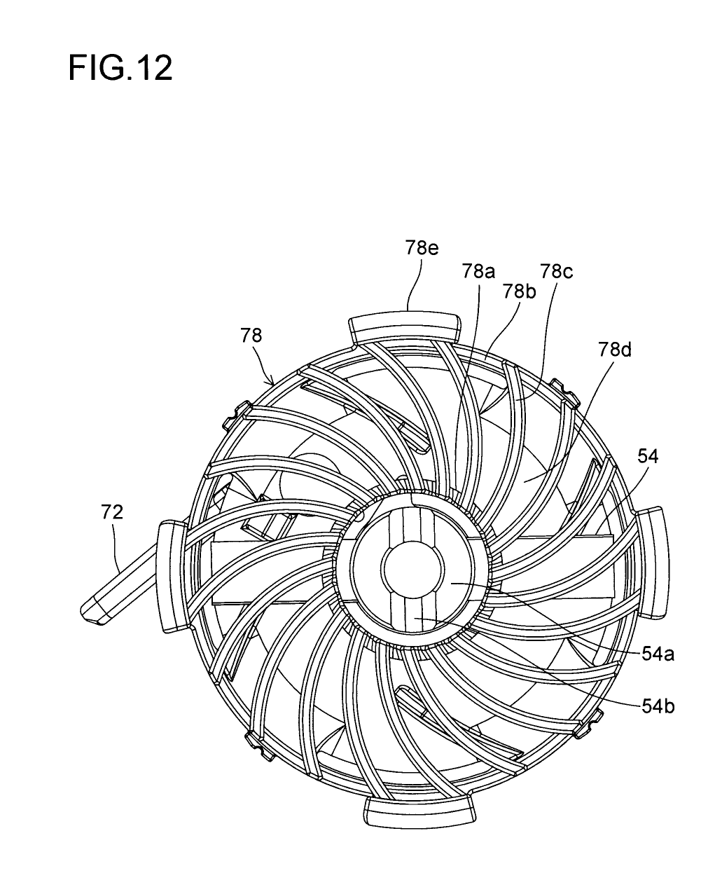

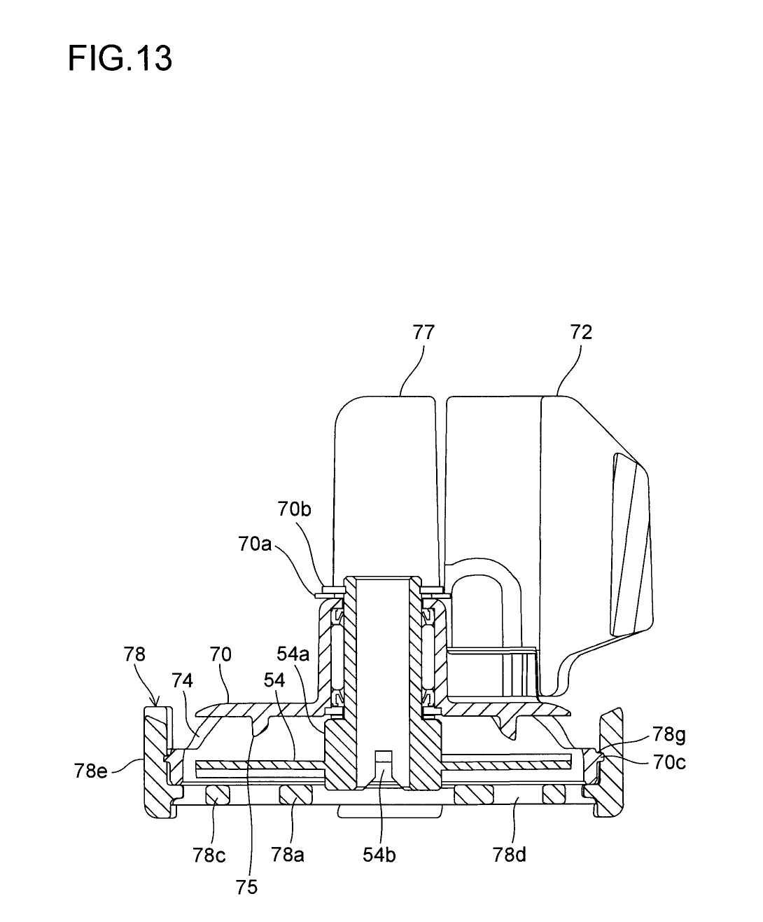

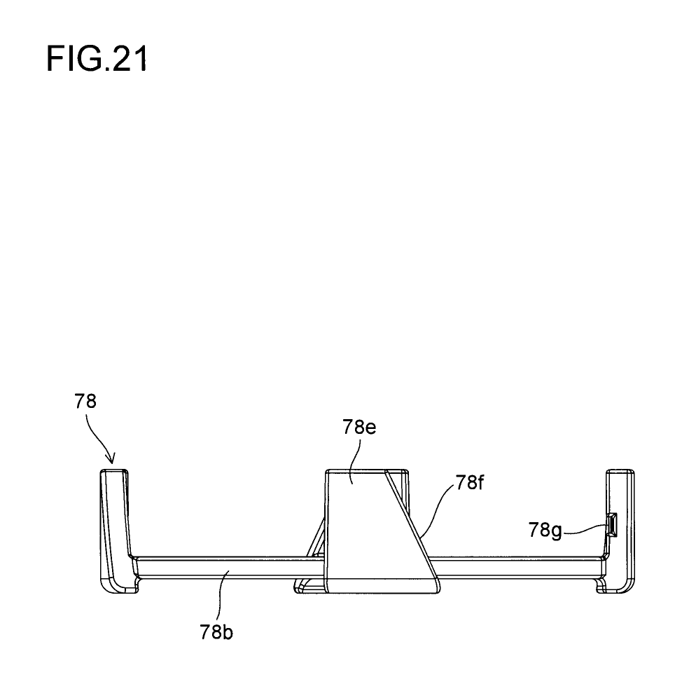

The automatic bread making machine of a second embodiment will now be described with reference to FIGS. 11 to 21. The automatic bread making machine of the second embodiment is obtained by modifying the automatic bread making machine 1 of the first embodiment; they have many common components. Hence, the same portions are identified with common symbols, and their description will not be repeated unless their description is especially needed.

The configuration of the main body 10, the operation portion 20, the lid 30 and the baking chamber 40 in the automatic bread making machine of the second embodiment is the same as in the automatic bread making machine 1 of the first embodiment. The configuration of the bread container support portion 13 provided within the baking chamber 40, the drive shaft 14 supported by the center shaft of the bread container support portion 13, the motors (the kneading motor 60 and the grinding motor 64) that provide the rotation force to the drive shaft 14 and a power transmission portion is the same as in the automatic bread making machine 1 of the first embodiment. Furthermore, the relationship between the control device 80 and the other components is the same as in the automatic bread making machine 1 of the first embodiment.

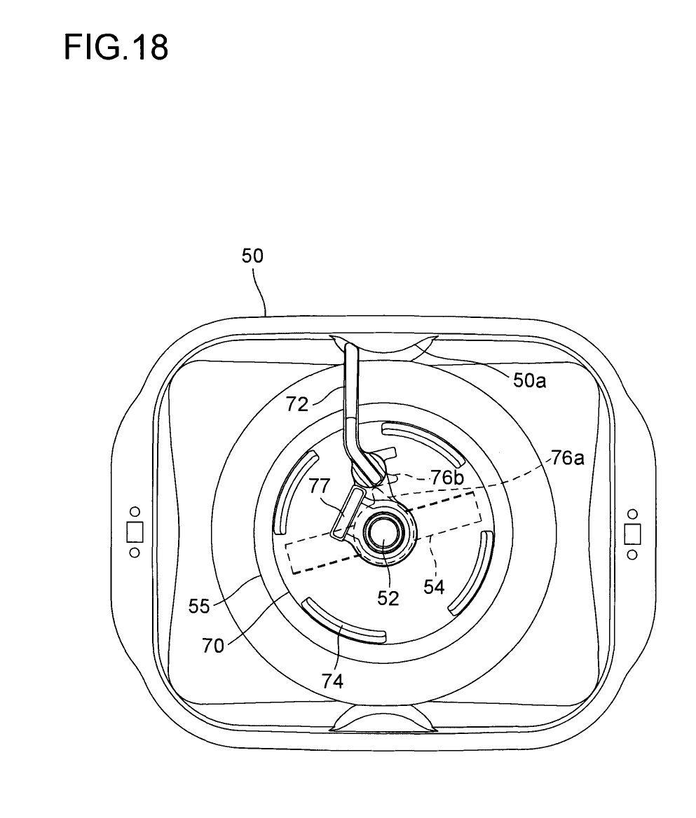

The configuration of the bread container 50 is substantially the same as in automatic bread making machine 1 of the first embodiment except that, as shown in FIG. 18, in the centers of the two surfaces corresponding to the long sides of the rectangle on the inner wall of the bread container 50, vertically extending ridge-shaped protrusions 50a are formed. The protrusions 50a are formed to help the kneading. The configuration in which the bread container support portion 13 receives the bread container 50 is the same as in the automatic bread making machine 1 of the first embodiment.

The configuration of the grinding blade 54 and the cover 70 attached to the blade rotation shaft 52 and their peripheral portions includes a configuration obtained by modifying the automatic bread making machine 1 of the first embodiment. Hence, although the same description is included, these configurations will be described below.

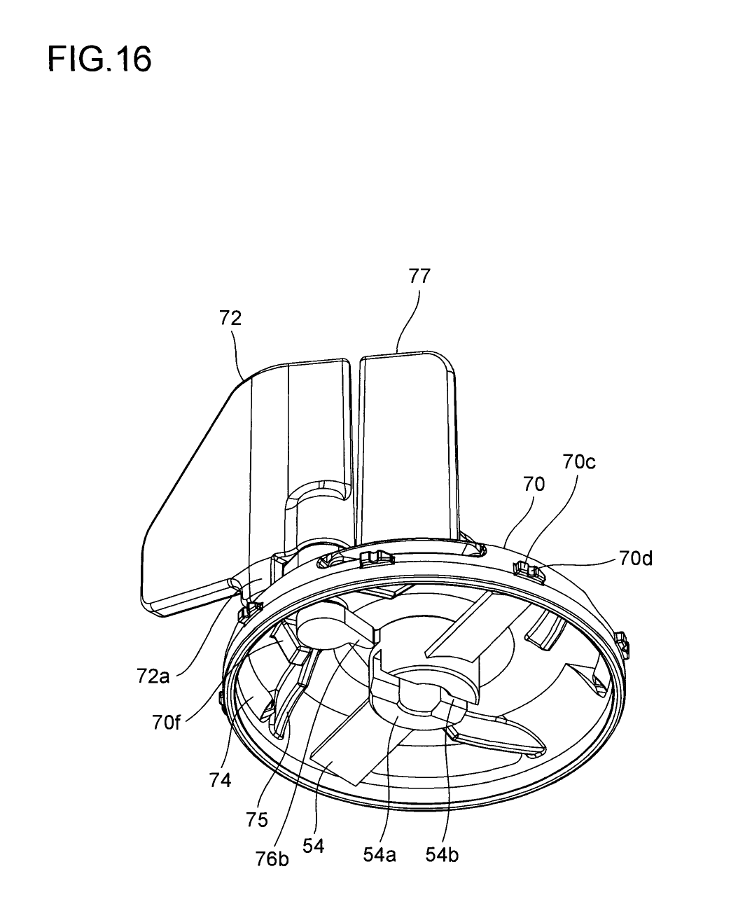

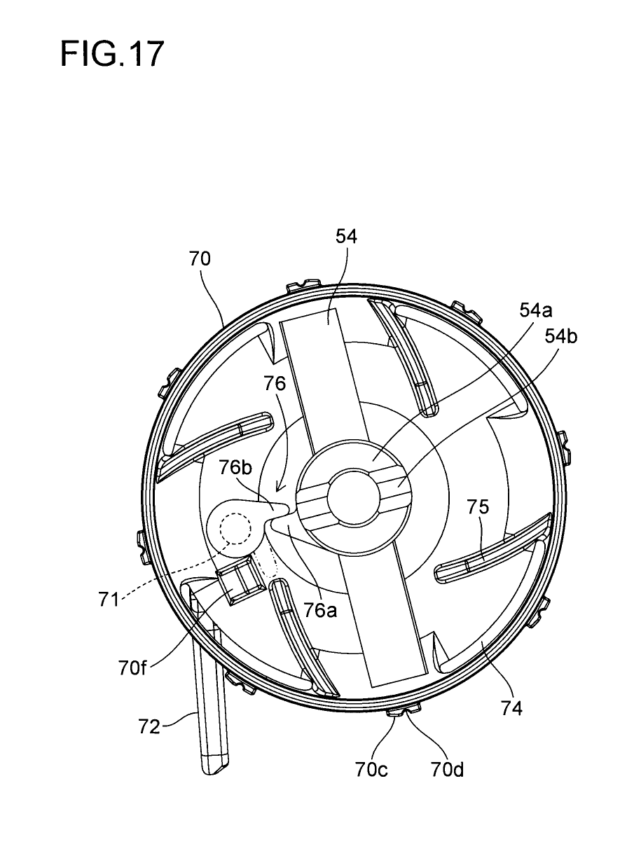

The grinding blade 54 (see FIG. 11) is attached to the blade rotation shaft 52 at a portion slightly above the bottom surface of the bread container 50. The grinding blade 54 is prevented from being rotated with respect to the blade rotation shaft 52. The grinding blade 54 is formed with a stainless steel plate; as shown in FIGS. 16 and 17, the grinding blade 54 is shaped like a propeller of an airplane.

The center portion of the grinding blade 54 is formed into the hub 54a that fits to the blade rotation shaft 52. In the lower surface of the hub 54a, the groove 54b is formed to extend diametrically across the hub 54a. A pin 52a that horizontally passes through the blade rotation shaft 52 receives the hub 54a and engages with the groove 54b, and the grinding blade 54 is coupled to the blade rotation shaft 52 such that the grinding blade 54 cannot be rotated with respect to the blade rotation shaft 52. Since the grinding blade 54 can easily be pulled out of the blade rotation shaft 52, it is possible to perform cleaning after the completion of the bread-making operation and replace a blunt blade with ease.

The dome-shaped cover 70 which functions as a kneading blade support member and whose shape is circular in plan view is attached to the upper end of the blade rotation shaft 52. The cover 70 is formed with a die casting of aluminum alloy, and surrounds and covers the grinding blade 54. The cover 70 is rotatably supported by the hub 54a of the grinding blade 54, and is prevented from being removed from the hub 54a by a washer 70a and a removal prevention ring 70b. In other words, in the present embodiment, the grinding blade 54 and the cover 70 constitute an unseparable unit, and the hub 54a of the grinding blade 54 also functions as a blade rotation shaft reception portion of the cover 70. Since the cover 70 can easily be pulled out of the blade rotation shaft 52 together with the grinding blade 54, it is possible to easily perform cleaning after the completion of the bread-making operation.

On the outer surface of the cover 70, the kneading blade 72 that is formed in the shape of an angle bracket in plan view is attached by the vertical pivot shaft 71 (see FIG. 17) arranged at a location away from the blade rotation shaft 52. The kneading blade 72 is also a die casting of aluminum alloy. The pivot shaft 71 is either fixed to or formed integrally with the kneading blade 72, and moves together with the kneading blade 72.

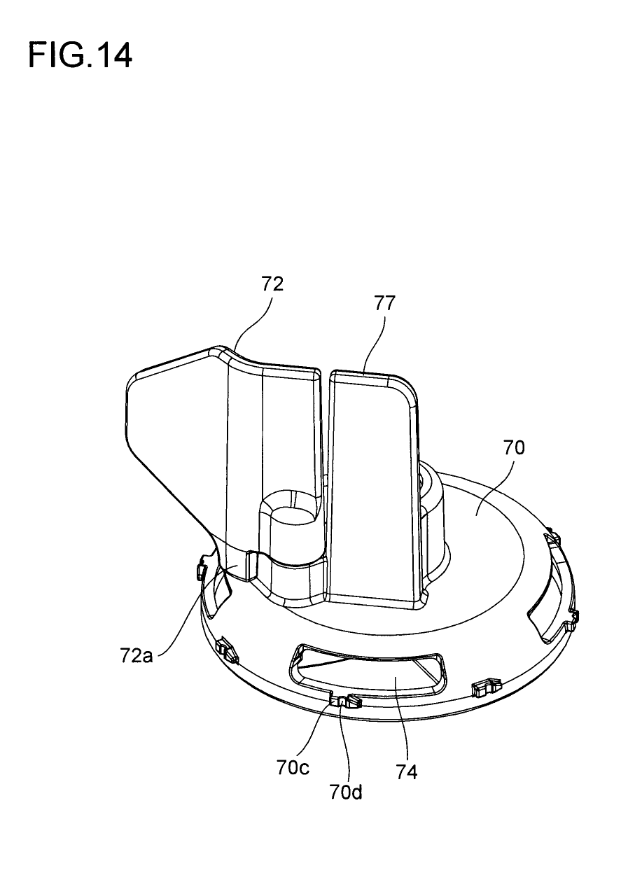

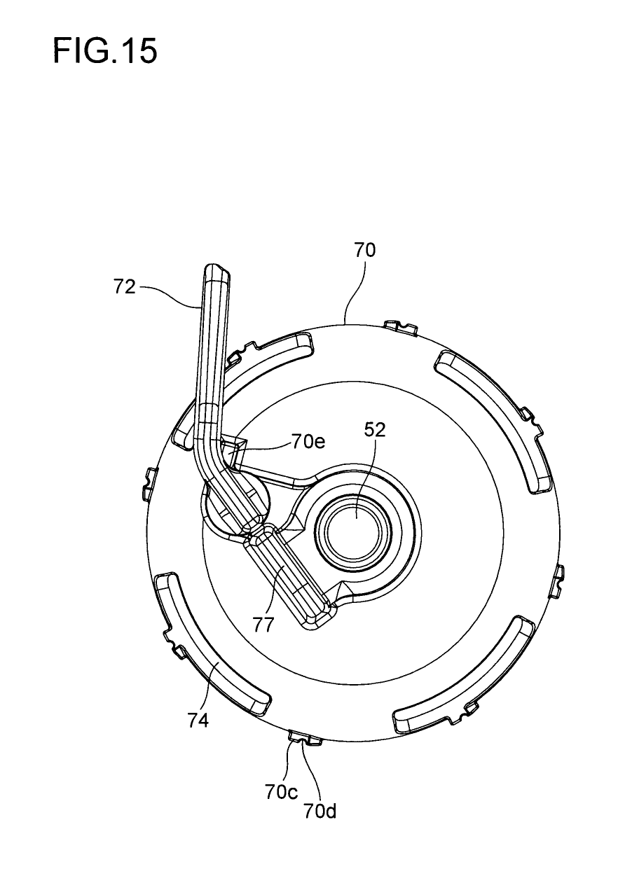

The kneading blade 72 is rotated on the shaft line of the pivot shaft 71 together with the pivot shaft 71, and takes two positions, that is, a folded position shown in FIGS. 14 to 17 and an open position shown in FIG. 18. In the folded position, a protrusion 72a (see FIG. 14) extending downward from the lower edge of the kneading blade 72 makes contact with a stopper portion 70e (see FIG. 15) formed on the upper surface of the cover 70, and thus cannot further be rotated clockwise (when seen from above) with respect to the cover 70. Here, the end of the kneading blade 72 slightly protrudes from the cover 70. Then, when the kneading blade 72 is rotated counterclockwise (when seen from above) and reaches the open position of FIG. 18, the end of the kneading blade 72 significantly protrudes from the cover 70.

In the cover 70, the windows 74 by which the space within the cover and the space outside the cover communicate with each other are formed. The windows 74 are arranged at the same height as the grinding blade 54 or slightly above the grinding blade 54. In the embodiment, the total of the four windows 74 are arranged at an angle of 90° with respect to each other; instead, a number other than the above number and an angle other than the above angle in the arrangement can be selected.

As shown in FIGS. 16 and 17, the total of the four ribs 75 corresponding to the windows 74 are formed on the inner surface of the cover 70. Each of the ribs 75 extends, obliquely with respect to the radial direction, from the vicinity of the center of the cover 70 to the outer circumferential ring-shaped wall; the four ribs are combined to form a four-comma shape. Each rib 75 is curved such that its side opposite the bread-making ingredients coming to the rib is convex.

The clutch 76 (see FIG. 17) intervenes between the cover 70 and the blade rotation shaft 52. The clutch 76 couples the blade rotation shaft 52 to the cover 70 in the rotation direction (the rotation in this direction is referred to as the “forward direction rotation” and is the clockwise rotation in FIG. 17) of the blade rotation shaft 52 when the kneading motor 60 for kneading the bread-making ingredients rotates the drive shaft 14. On the other hand, the clutch 76 disconnects the coupling between the blade rotation shaft 52 and the cover 70 in the rotation direction (the rotation in this direction is referred to as the “opposite direction rotation” and is the counterclockwise rotation in FIG. 17) of the blade rotation shaft 52 when the grinding motor 64 for grinding cereal grains rotates the drive shaft 14. In FIG. 18 the “forward direction rotation” is counterclockwise rotation, and the “opposite direction rotation” is clockwise rotation.

The clutch 76 is formed with the first engagement member 76a and the second engagement member 76b. The first engagement member 76a is either fixed to or formed integrally with the hub 54a of the grinding blade 54, and thus the first engagement member 76a is attached such that the first engagement member 76a cannot be rotated with respect to the blade rotation shaft 52. The second engagement member 76b is either fixed to or formed integrally with the pivot shaft 71 of the kneading blade 72, and thus the angle is changed as the position of the kneading blade 72 is changed.

The clutch 76 changes the coupling state according to the position of the kneading blade 72. Specifically, when the kneading blade 72 is in the folded position, the second engagement member 76b is arranged at an angle of FIG. 17. Here, the second engagement member 76b interferes with the rotational orbit of the first engagement member 76a; when the blade rotation shaft 52 is rotated clockwise in FIG. 17, that is, is rotated in the forward direction, the first engagement member 76a engages with the second engagement member 76b, with the result that the rotation force of the blade rotation shaft 52 is transmitted to the cover 70 and the kneading blade 72. When the kneading blade 72 is in the open position, the second engagement member 76b is arranged at an angle of FIG. 18. Here, the second engagement member 76b retracts from the rotational orbit of the first engagement member 76a; even when the blade rotation shaft 52 is rotated clockwise in FIG. 18, that is, is rotated in the opposite direction, the first engagement member 76a does not engage with the second engagement member 76b. Therefore, the rotation force of the blade rotation shaft 52 is not transmitted to the cover 70 and the kneading blade 72.

The opening angle at which the kneading blade 72 is opened is limited by a stopper portion 70f (see FIGS. 16 and 17) formed on the inner surface of the cover. That is, the angle formed when the second engagement member 76b makes contact with the stopper portion 70f is the maximum open angle of the kneading blade 72.

A complementary kneading blade 77 is formed on the outer surface of the cover 70 next to the kneading blade 72. The complementary kneading blade 77 is aligned with the kneading blade 72 that is in the folded position. Specifically, when the kneading blade 72 is in the folded position, the complementary kneading blade 77 is aligned in the direction in which the kneading blade 72 extends, and it appears as if the shape of the angle bracket of the kneading blade 72 is increased in size.

In the bottom portion of the bread container 50, the concave portion 55 that accommodates the grinding blade 54 and the cover 70 is formed. The concave portion 55 is circular in plan view, and the gap 56 that allows the flow of the bread-making ingredients is formed between the outer circumferential portion of the cover 70 and the inner surface of the concave portion 55.

A guard 78 that covers the lower surface of the cover 70 to prevent access of a finger to the grinding blade 54 is removably attached to the cover 70. The guard 78 has a mechanism shown in FIG. 20. Specifically, a ring-shaped hub 78a through which the blade rotation shaft 52 passes is arranged in the center, and a ring-shaped rim 78b is arranged in the outer edge. The hub 78a and the rim 78b are coupled together by a plurality of spokes 78c. The spaces between the spokes 78c function as opening portions 78d which the cereal grains to be ground pass through. The size of the opening portions 78d is set to such a degree that the finger cannot pass through the opening portions 78d.

When the guard 78 is attached to the cover 70, the guard 78 is close to the grinding blade 54. Specifically, the guard 78 is close to the grinding blade 54 to such a degree that the spokes 78c do not make contact with the grinding blade 54. It appears as if the guard 78 and the grinding blade 54 are shaped like an outside blade and an inside blade of a rotary electric shaver, respectively.

The spokes 78c do not extend linearly along the radius of the guard 78. The spokes 78c extend such that, when the blade rotation shaft 52 is rotated in the forward direction (counterclockwise when seen from above), and the cover 70 and the guard 78 is also rotated in the forward direction, the side of the center of the guard 78 moves ahead (passes through a reference diameter line earlier), and the side of the outer edge moves behind (passes through the reference diameter line later). Although, in the embodiment, the spokes 78c are curved, they may extend linearly.

On the outer edge of the guard 78, a plurality of posts 78e that surround the cover 70 are formed integrally with the rim 78b such that the posts 78e are arranged at a predetermined angle with respect to each other. In the embodiment, the total of the four posts 78e are arranged at an angle of 90° with respect to each other. The side surface 78f of the post 78e that is the front surface in the direction of rotation when the blade rotation shaft 52 is rotated in the forward direction is inclined upward. The lower end of the post 78e protrudes downward beyond the spokes 78c.

The posts 78e also function to couple the guard 78 to the cover 70. In the side surface toward the side of the center of the guard, a groove 78g with one end extending halfway across the side surface is formed. The corresponding protrusions 70c that engage with the grooves 78g are formed, as shown in FIG. 14, in the outer circumference of the cover 70. In the embodiment, the total of the eight protrusions 70c are arranged at an angle of 45° with respect to each other.

The grooves 78g and the protrusions 70c form bayonet coupling. The direction in which the guard 78 is turned when the grooves 78g engage with the protrusions 70c coincides with the opposite rotation direction of the blade rotation shaft 52. Hence, even when the cover 70 is rotated in the forward direction to perform the kneading, the guard 78 is prevented from being disconnected from the cover 70.

When the blade rotation shaft 52 is rotated in the opposite direction so that the cereal grains are ground with the grinding blade 54, the resulting flow of the cereal grains and fluid causes a pressure to be applied to the guard 78. However, since the direction of the pressure coincides with the direction in which the guard 78 is turned when attached, in this case, the guard 78 is also prevented from being disconnected from the cover 70.

In order to prevent the guard 78 from being easily disconnected from the cover 70, a mechanism for producing a resistance against the turning in the direction of the removal is provided between the posts 78e and the cover 70. Specifically, a protrusion 78h that vertically extends like a ridge is formed within the groove 78g, and a concave portion 70d that engages with the protrusion 78h is formed in the protrusion 70c. At the final stage of the turning when the guard 78 is attached, the protrusion 78h elastically engages with the concave portion 70d. In this way, a predetermined resistance is produced against the turning in the direction of the removal of the guard 78.

The guard 78 is molded of a heat-resistant engineering plastic, for example, a polyphenylene sulfide (PPS).

Incidentally, the blade rotation shaft 52 is formed of metal; the hub 54a of the grinding blade 54 that serves as a blade rotation shaft reception portion of the cover 70 is also formed of metal. A heat insulation layer is formed on one or both of the surfaces of the portion where the blade rotation shaft 52 engages with the hub 54a and the inner surface of the hub 54a. In the present embodiment, as shown in FIG. 3, the end portion of the blade rotation shaft 52 is covered by a cap-shaped heat insulation layer 79. The heat insulation layer 79 extends downward beyond the grinding blade 54. Synthetic resin can be injection molded into the heat insulation layer 79 while the end portion of the blade rotation shaft 52 is placed into a mold; in other words, the heat insulation layer 79 can be formed by so-called insert molding. As the resin material of the heat insulation layer 79, an engineering plastic having excellent heat resistance and strength, for example, a polyacetal (POM) is employed.

(Bread Making Using the Automatic Bread Making Machine)

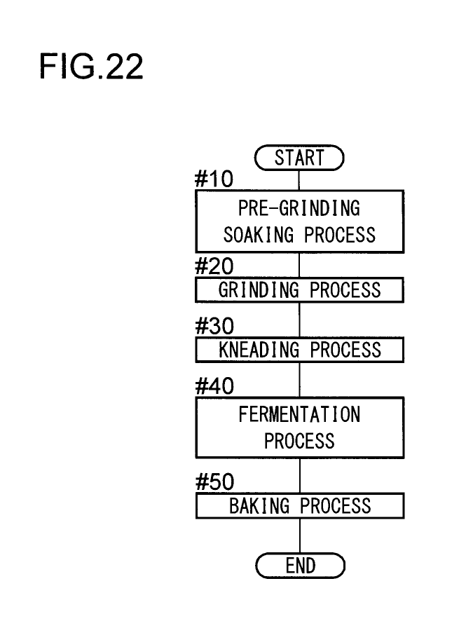

A process of making bread from the cereal grains with the automatic bread making machine of the embodiment will now be described with reference to FIGS. 22 to 33. The manipulation, the operation and the like in the bread making using the automatic bread making machine 1 of the first embodiment are substantially the same as those in the bread making using the automatic bread making machine (hereinafter also represented by reference numeral 1) of the second embodiment. Hence, the bread making using the automatic bread making machine 1 of the second embodiment will only be described below.

Before the start of the bread making process, it is necessary to perform the preparation of the automatic bread making machine 1. As described above, the grinding blade 54 and the cover 70 constitute the unseparable unit. When a combination of the unit and the guard 78 is attached to the blade rotation shaft 52, since the guard 78 prevents access of a finger to the grinding blade 54, it is possible to reduce the possibility that the finger is injured by touching the grinding blade 54.

FIG. 22 is a flowchart of the entire first bread making process. As shown in FIG. 22, in the first bread making process, the process proceeds from a pre-grinding soaking process #10 to a grinding process #20 to a kneading process #30 to a fermentation process #40 and to a baking process #50 in this order. The details of each process will now be described.

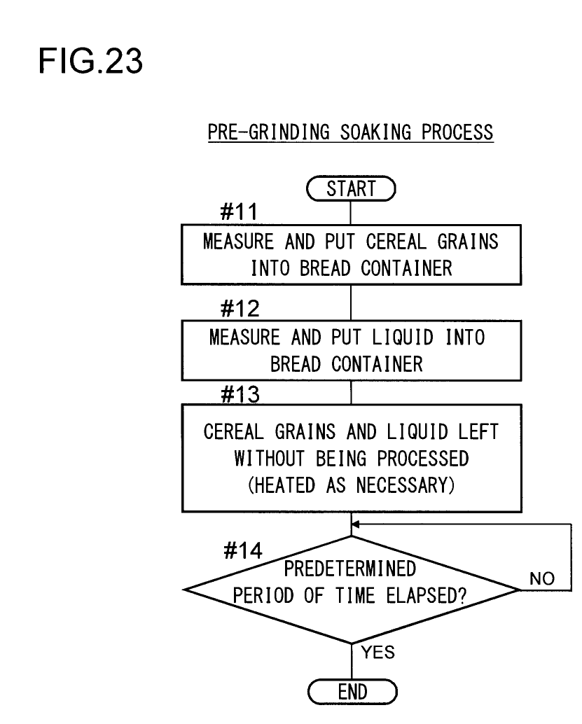

In the pre-grinding soaking process #10 shown in FIG. 23, first in step #11, a user measures the cereal grains to put a predetermined number of cereal grains into the bread container 50. As the cereal grains, rice grains are most readily available; other cereal grains, such as wheat, barley, chestnut, Japanese barnyard millet, soba and corn are also usable.

In step #12, the user measures a liquid and puts a predetermined amount of liquid into the bread container 50. Although water is commonly used as the liquid, a liquid such as a soup stock having taste components may be used or a fruit juice may be used. The liquid may contain alcohol. The order of the step #11 and the step #12 may be reversed.

The operation of putting the cereal grains and the liquid into the bread container 50 may be performed either after the removal of the bread container 50 from the baking chamber 40 or with the bread container 50 placed in the baking chamber 40.

The cereal grains and the liquid are put into the bread container 50 within the baking chamber 40, or the bread container 50 which the cereal grains and the liquid have been put into outside the automatic bread making machine is attached to the bread container support portion 13, and then the lid 30 is closed. Here, the user presses a predetermined operation key in the operation portion 20, and thus the counting of a time during which the liquid soaks is started. At this point, step #13 is started.

In step #13, the mixture of the cereal grains and the liquid is left within the bread container 50 without being processed, and thus the liquid soaks into the cereal grains. Since, in general, the soaking is facilitated as the temperature of the liquid is increased, the heating device 41 is energized and thus the temperature of the baking chamber 40 may be increased.

In step #14, the control device 80 checks how much time has elapsed since the start of the leaving of the cereal grains and the liquid. When a predetermined period of time has elapsed, the pre-grinding soaking process #10 is completed. The user is notified of this information such as by a display on the operation portion 20 or sound.

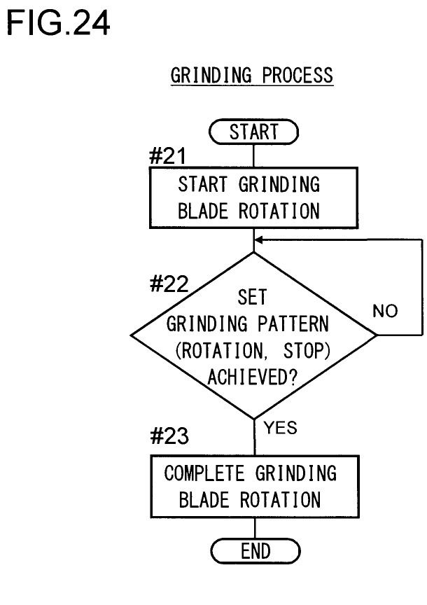

After the pre-grinding soaking process #10, the grinding process #20 shown in FIG. 24 is performed. When the user inputs grinding operation data (such as the type and amount of cereal grains and the type of bread to be baked) through the operation portion 20, and presses the start key, step #21 is started.

In step #21, the control device 80 drives the grinding motor 64 and rotates the blade rotation shaft 52 in the opposite direction. Then, within the mixture of the cereal grains and the liquid, the grinding blade 54 starts to be rotated. The cover 70 also starts to be rotated together with the blade rotation shaft 52. The direction of rotation of the cover 70 at this point is the clockwise direction in FIG. 18; when the kneading blade 72 has so far been in the folded position, the kneading blade 72 is brought into the open position by the resistance received from the mixture of the cereal grains and the liquid. When the kneading blade 72 reaches the open position, the second engagement member 76b retracts from the rotational orbit of the first engagement member 76a, and thus the clutch 76 disconnects the coupling between the blade rotation shaft 52 and the cover 70. At the same time, the kneading blade 72 in the open position makes contact with the protrusion 50a of the inner wall of the bread container 50 as shown in FIG. 18, and prevents the rotation of the cover 70. Thereafter, the blade rotation shaft 52 and the grinding blade 54 is rotated at a high speed in the opposite direction.

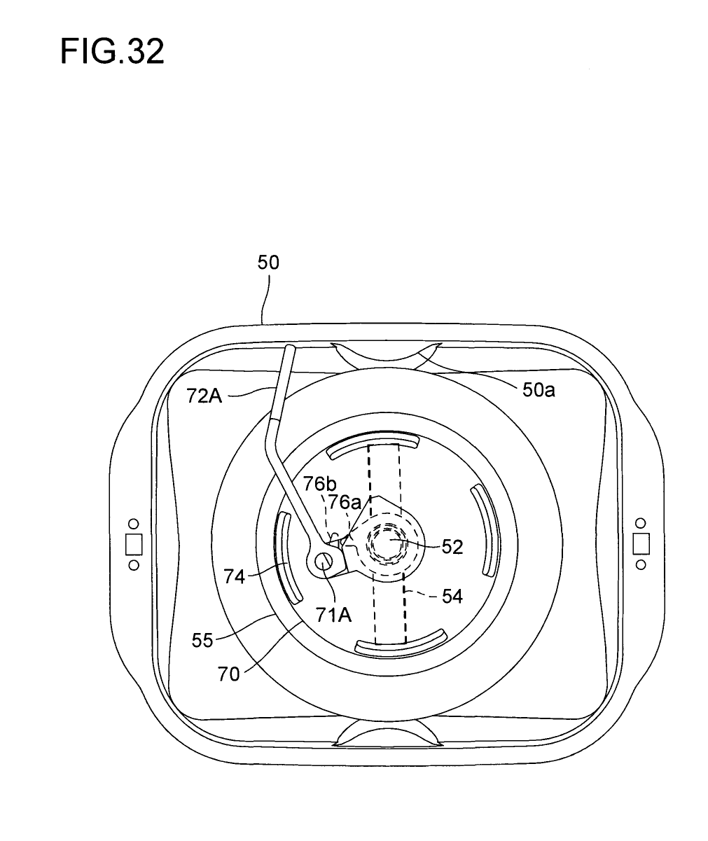

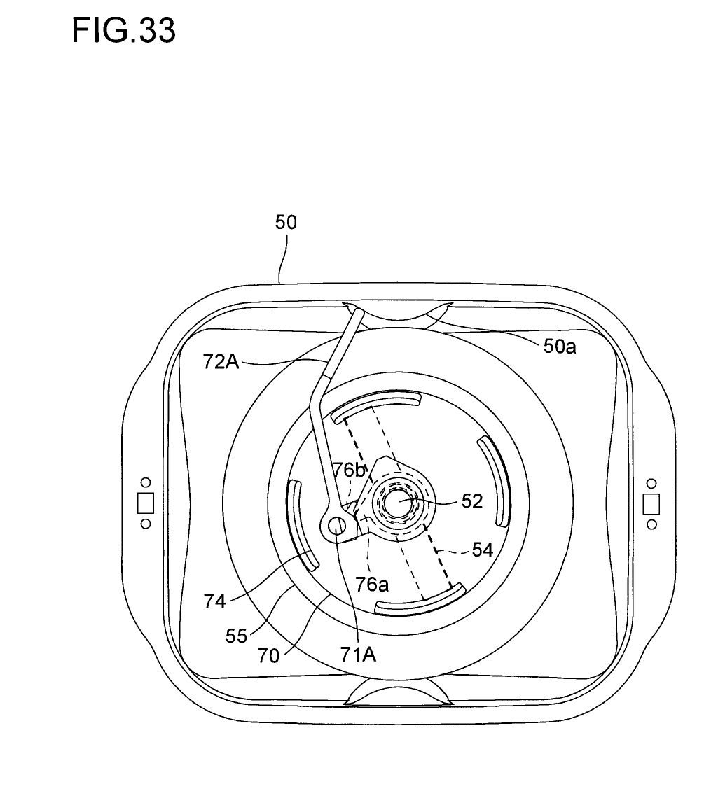

When the blade rotation shaft 52 is rotated in the opposite direction, the kneading blade 72 that is in an incomplete open position may make contact with the protrusion 50a. When consideration is not given to the radius of rotation of the kneading blade 72, the following problem can occur. FIGS. 32 and 33 are imaginary top views showing an example of a structure that is not designed according to the present invention. The components other than the pivot shaft and the kneading blade are identified with the symbols used in the description of the embodiments of the present invention.

In the example of the structure of FIGS. 32 and 33, the location of a pivot shaft 71A is different from that in the embodiments of the present invention. The radius of rotation from the center of the pivot shaft 71A to the end of a kneading blade 72A is about equal to the sum of the lengths of the kneading blade 72 and the complementary kneading blade 77.

If the radius of rotation of the kneading blade 72A is large as described above, the cover 70 is stopped not only when, shown in FIG. 32, the kneading blade 72 in the open position makes contact with the inner wall of the bread container 50 but also when, as shown in FIG. 33, the kneading blade 72 in the incomplete open position makes contact with the protrusion 50a. Since, in this state, the second engagement member 76b does not retract from the rotational orbit of the first engagement member 76a, when the first engagement member 76a comes to that place, the kneading blade 72 in the position of FIG. 33 is pressed against the protrusion 50a and therefore cannot move. Thus, a rotation system including the kneading blade 72 and the grinding motor 64 is stopped, and consequently, the grinding motor 64 may burn.

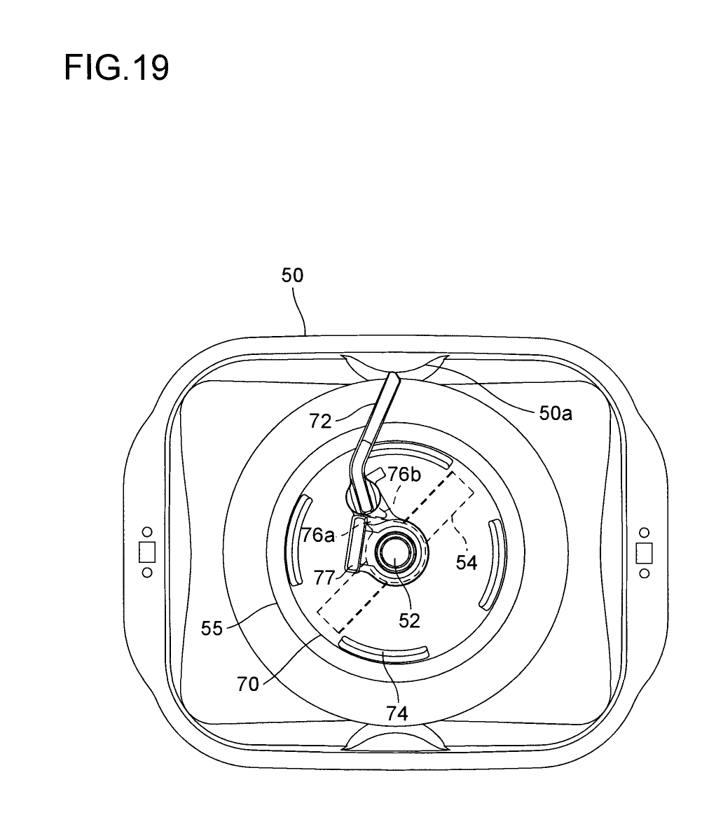

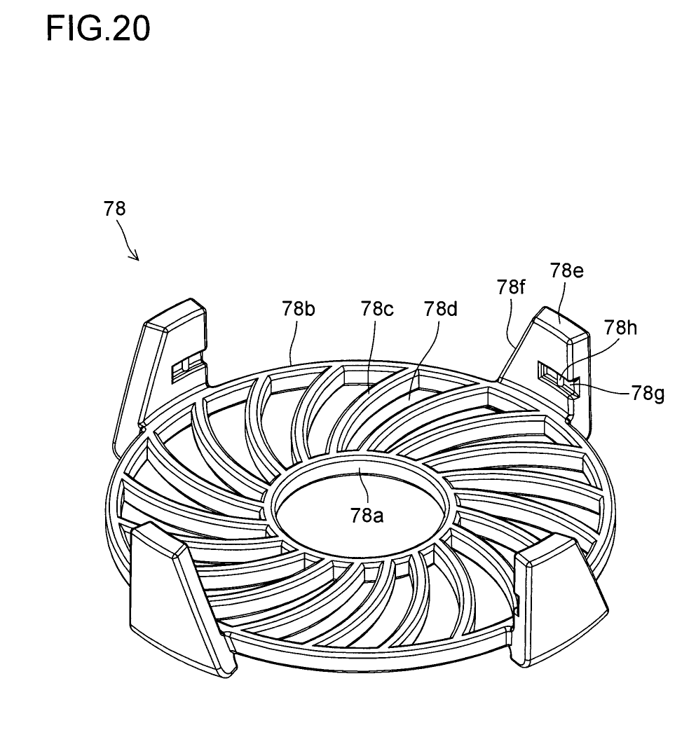

In view of the above problem, in the present invention, the value of the radius of rotation from the center of the pivot shaft 71 to the end of the kneading blade 72 is set such that the kneading blade 72 in the incomplete position which makes contact with the protrusion 50a can pass around the area of contact with the protrusion 50a without the position being changed. Since the kneading blade 72 of FIG. 19 thereafter passes around the protrusion 50a, the rotation system including the kneading blade 72 and the grinding motor 64 is not stopped, with the result that the grinding motor 64 is prevented from burning. Since the kneading blade 72 that has passed around the upper protrusion 50a of FIG. 19 is brought into the complete open position by the time when it reaches the lower protrusion 50a of FIG. 19, the same problem is not repeated at the lower protrusion 50a of FIG. 19.

Since, as described above, the kneading blade 72 in the open position makes contact with the protrusion 50a and thus the cover 70 and the kneading blade 72 are stopped, even if the grinding blade 54 is rotated at a high speed, the mixture of the cereal grains and the liquid does not swirl within the bread container 50. Hence, the swirled mixture is prevented from expanding around the outer edge, with the result that the swirled mixture does not spill out of the bread container 50.

While the kneading blade 72 makes contact with the protrusion 50a to stop the rotation of the cover 70, the rotation of the guard 78 is also stopped. The cereal grains that have entered the cover 70 through the opening portions 78d of the guard 78 are sheared between the still spokes 78c and the rotating grinding blade 54, and thus the grinding function is enhanced.

Since the grinding by the grinding blade 54 is performed with the liquid soaking into the cereal grains, it is possible to easily grind even the cores of the cereal grains. The ribs 75 extending from the vicinity of the center of the cover 70 to the outer circumferential wall prevent the flow of the mixture of the cereal grains and the liquid in the same direction as the direction of rotation of the grinding blade 54, and this helps the grinding. In other words, the ribs 75 change the flow of the mixture, and this acts to increase the rate of collision with the grinding blade 54. Since the grinding is performed within the cover 70, the cereal grains are prevented from being dispersed from the bread container 50.

The mixture of the ground cereal grains and the liquid is guided by the ribs 75 toward the windows 74, and are discharged out of the cover 70 through the windows 74. Since the rib 75 is curved such that its side opposite the mixture of the cereal grains and the liquid coming to the rib is convex, the mixture of the cereal grains and the liquid is unlikely to remain on the surface of the ribs 75, and smoothly flows toward the windows 74.

Whereas the mixture of the cereal grains and the liquid is discharged out of the cover 70, the mixture of the cereal grains and the liquid present in a space on the concave portion 55 instead enters the concave portion 55 through the gap 56, and then enters the cover 70 from the concave portion 55 through the opening portions 78d of the guard 78. The cereal grains are ground by the grinding blade 54 within the cover 70, and return to the space on the concave portion 55 through the windows 74 of the cover 70. By grinding the cereal grains while they are circulated in this way, it is possible to effectively grind the cereal grains. As described previously, the spokes 78c of the guard 78 help the grinding of the cereal grins. The ground mixture produced by the grinding blade 54 is rapidly guided by the ribs 75 toward the windows 74, and does not remain within the cover 70, with the result that the grinding function is further enhanced.

Since the windows 74 are arranged at the same height as the grinding blade 53 or slightly above the grinding blade 53, the direction in which the mixture of the ground cereal grains and the liquid is discharged through the cover 70 points horizontally or obliquely upward, with the result that the circulation of the cereal grains is facilitated.

In step #22, the control device 80 checks whether or not a preset grinding pattern (including: whether the grinding blade is continuously rotated; whether the grinding blade is intermittently rotated with intervening stop periods; and, when it is intermittently rotated, what intervals are used and how much time the rotation is performed) has been achieved so as to obtain the desired ground cereal grains.

After the preset grinding pattern has been achieved, the process proceeds to step #23 where the rotation of the grinding blade 54 is completed, with the result that the grinding process #20 is completed. The user is notified of this information such as by a display on a display portion 22 or sound.

Although, in the above description, the pre-grinding soaking process #10 is performed, and thereafter the grinding process #20 is started by the operation of the user, when the user inputs the grinding operation data before or halfway through the pre-grinding soaking process #10, the grinding process #20 may be automatically stated after the completion of the pre-grinding soaking process #10.

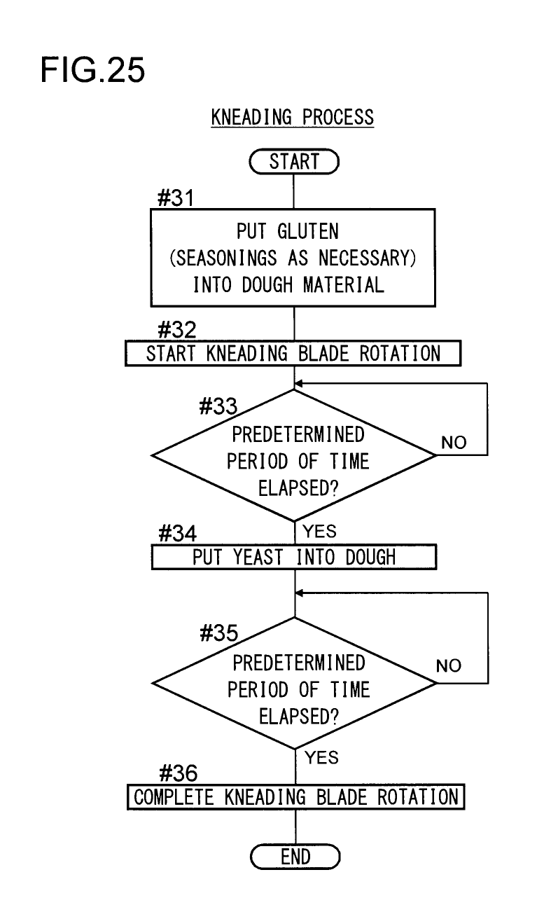

After the grinding process #20, the kneading process #30 shown in FIG. 25 is performed. When the kneading process #30 is started, the cereal grains and the liquid within the bread container 50 have become a dough material that is either a paste or a slurry. In the present specification, the mixture at the time when the kneading process #30 is started is referred to as a “dough material”; the mixture that is brought into a state close to a desired dough state by being kneaded is referred to as a “dough” ever if the mixture is in an incomplete state.

In step #31, the user opens the lid 30 and puts a predetermined amount of gluten into the dough material. As necessary, seasonings such as salt, sugar and shortening are also put thereinto. Alternatively, the automatic bread making machine 1 can be provided with an automatic feeder for feeding the gluten and the seasonings, and thus it is possible to feed them without bothering the user.

Around step #31, the user inputs the type of bread and the type of cooking through the operation portion 20. After the completion of the preparation, when the user presses the start key, the bread making operation of automatically and continuously performing the kneading process #30, the fermentation process #40 and then the baking process #50 is started.

In step #32, the control device 80 drives the kneading motor 60. When the blade rotation shaft 52 is rotated in the forward direction, the grinding blade 54 is also rotated in the forward direction, and the dough material around the grinding blade 54 flows in the forward direction. When the cover 70 is moved in the forward direction accordingly, the kneading blade 72 receives a resistance from the dough material, with the result that the open position is changed to the folded position as the angle is changed. When the angle of the kneading blade 72 is changed to such an angle that the second engagement member 76b interferes with the rotational orbit of the first engagement member 76a, the coupling of the clutch 76 is formed, and the cover 70 is actually ready to be driven by the blade rotation shaft 52. The kneading blade 72 is also brought into the complete folded position. Thereafter, the cover 70 and the kneading blade 72 are rotated in the forward direction together with the blade rotation shaft 52.

When the kneading blade 72 is brought into the folded position, the complementary kneading blade 77 is aligned in the direction in which the kneading blade 72 extends, and it appears as if the shape of the angle bracket of the kneading blade 72 is increased in size, with the result that the dough material is forced out. Thus, it is possible to reliably perform the kneading.

The guard 78 is also rotated in the forward direction together with the cover 70. Since, as described above, the spokes 78c are shaped such that, when they are rotated in the forward direction, the side of the center of the guard 78 moves ahead, and the side of the outer edge moves behind, the guard 78 is rotated in the forward direction and thus the dough material inside and outside the cover 70 is forced to the outside by the spokes 78c. Thus, it is possible to reduce the proportion of the dough that is discarded when the cover 70 is removed from the baked bread.

Since, as described above, in the post 78e of the guard 78, the side surface 78f that is the front surface in the direction of rotation when the guard 78 is rotated in the forward direction is inclined upward, when the kneading is performed, the dough material around the cover 70 is sprung up by the front surface of the posts 78e and is combined with the body of the dough material arranged above. Thus, it is possible to reduce the amount of the dough that is discarded because it is not combined as part of the bread.

In step #32, the control device 80 energizes the heating device 41 to increase the temperature of the baking chamber 40. As the kneading blade 72 and the complementary kneading blade 77 are rotated, the dough material is kneaded into one continuous piece of dough having a predetermined amount of elasticity. The kneading blade 72 and the complementary kneading blade 77 rotate and hit the dough against the inner wall of the bread container 50, especially against the protrusions 50a, with the result that the “squeezing” is added to the kneading.

As the cover 70 is rotated, the ribs 75 are also rotated. The ribs 75 are rotated, and thus the dough material within the cover 70 is rapidly discharged through the windows 74, with the result that the discharged dough material is incorporated into a lump of dough material kneaded by the kneading blade 72 and the complementary kneading blade 77.

In step #33, the control device 80 checks how much time has elapsed since the start of the rotation of the kneading blade 72 and the complementary kneading blade 77. When a predetermined period of time has elapsed, the process proceeds to step #34.

In step #34, the user opens the lid 30 and puts yeast into the dough. The yeast that is put into the dough at this time may be dry yeast. Instead of yeast, baking powder may be used. An automatic feeder for the yeast or the baking powder is also employed, and thus it is possible to eliminate the operation performed by the user.

In step #35, the control device 80 checks how much time has elapsed since the yeast had been put into the dough. When a period of time necessary for obtaining the desired dough has elapsed, the process proceeds to step #36 where the rotation of the kneading blade 72 and the complementary kneading blade 77 is completed. Here, one continuous piece of dough having a necessary amount of elasticity has been completed. Most of the dough is left on or above the concave portion 55; only a slight amount of the dough enters the concave portion 55.

When optional ingredient-containing bread is baked, an optional ingredient is fed at any step in the kneading process #30. It is also possible to employ an automatic feeder for feeding an optional ingredient.

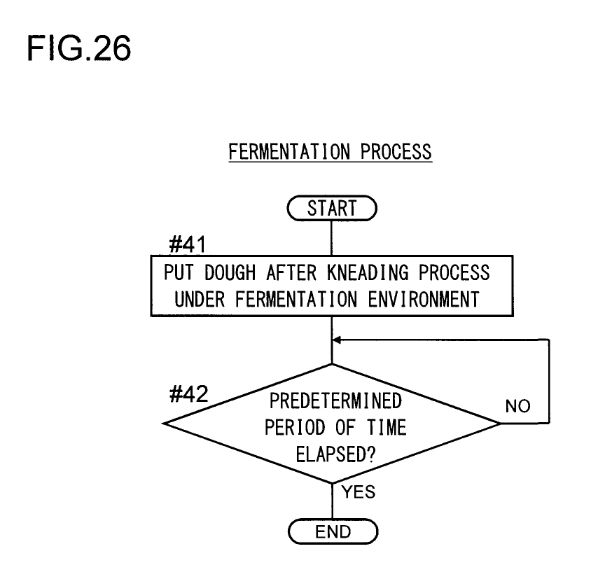

After the kneading process #30, the fermentation process #40 shown in FIG. 26 is performed. In step #41, the dough that has been subjected to the kneading process #30 is placed under a fermentation environment. Specifically, the control device 80 changes, by energizing the heating device 41 when necessary, the temperature of the baking chamber 40 to any temperature within a temperature range suitable for facilitating fermentation. The user adjusts the shape of the dough as necessary and leaves it without being processed.

In step #42, the control device 80 checks how much time has elapsed since the dough had been placed under the fermentation environment. When a predetermined period of time has elapsed, the fermentation process #40 is completed.

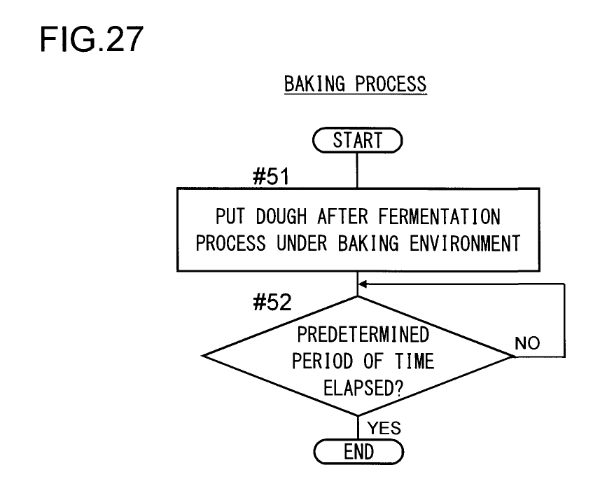

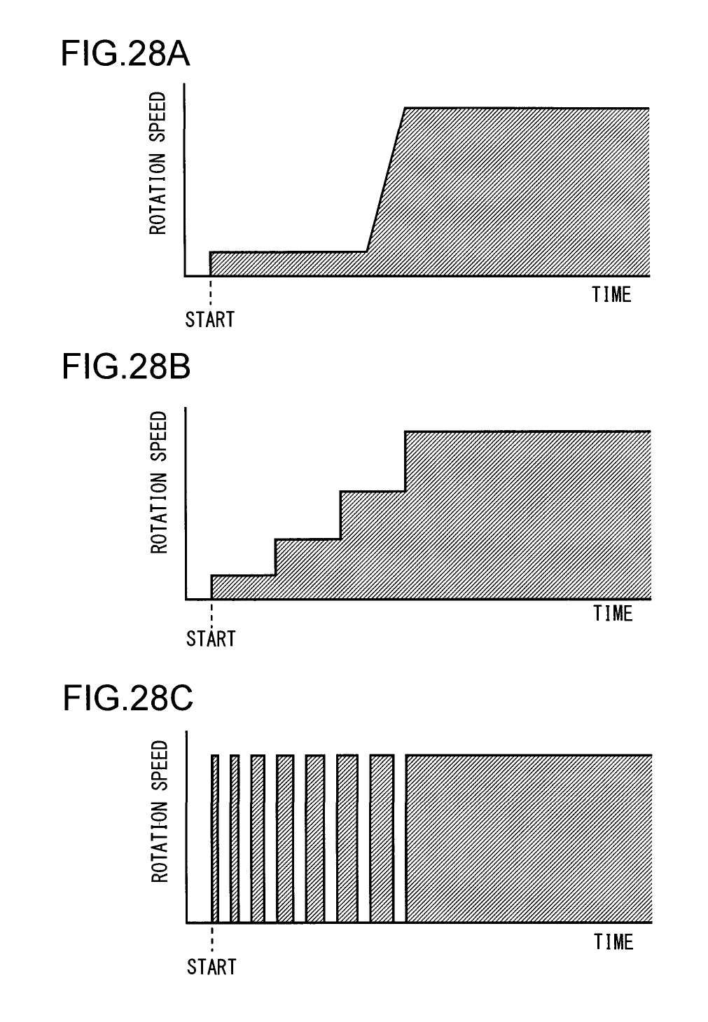

After the fermentation process #40, the baking process #50 shown in FIG. 27 is performed. In step #51, the fermented dough is placed under a baked environment. Specifically, the control device 80 feeds a necessary amount of power for baking the bread to the heating device 41, and thereby increases the temperature of the baking chamber 40 to any temperature within a temperature range suitable for baking the bread.

In step #52, the control device 80 checks how much time has elapsed since the dough had been placed under the baked environment. When a predetermined period of time has elapsed, the baking process #50 is completed. Here, since the user is notified of the completion of the bread making by a display on the display portion 22 or sound, the user opens the lid 30 and takes out the bread container 50. Then, the user takes the bread out of the bread container 50. Although a mark of the removal of the kneading blade 72 is left on the bottom of the bread, since the cover 70 and the guard 78 are accommodated within the concave portion 55 and do not protrude beyond the bottom portion of the bread container 50, a large mark of the removal is prevented from being left on the bottom of the bread.

After the bread is taken out, the unit of the grinding blade 54 and the cover 70 is taken out of the bread container 50. When the guard 78 is taken out of the unit and is placed on the placement surface of a table or the like, since the guard 78 is formed of synthetic resin that is unlikely to transmit heat, the guard 78 can be utilized as a stage for cooling the bread that has been taken out.

Since the lower ends of the posts 78e protrude beyond the spokes 78c, when the guard 78 is placed on the placement surface, the spokes 78c are raised off the placement surface and thus a space for air circulation is formed under the spokes 78c. Hence, for example, when it is desirable to cool the guard 78 itself or the cover 70 and the grinding blade 54 that are supported by the guard 78, it is possible to cool them rapidly.

If the metallic surfaces of the blade rotation shaft 52 and the hub 54a of the grinding blade 54 that receives the blade rotation shaft 52 face each other, the dough that enters a small gap therebetween is burned and left, and thus it may be difficult to remove the unit of the grinding blade 54 and the cover 70 from the blade rotation shaft 52. However, since, in the present embodiment, the heat insulation layer 79 is formed on the surface of the blade rotation shaft 52, even if the dough enters the gap between the blade rotation shaft 52 and the hub 54a, it is unlikely that the dough is burned and left. Since the hub 54a itself is part of the grinding blade 54, the problem of the dough that is burned and left between the grinding blade 54 and the blade rotation shaft 52 has been already solved. It is therefore possible to easily remove the unit of the grinding blade 54 and the cover 70.

The heat insulation layer 79 can also be formed not on the blade rotation shaft 52 but on the inner surface of the hub 54a. The heat insulation layer 79 can also be formed both on the outer surface of the blade rotation shaft 52 and on the inner surface of the hub 54a.

When the heat insulation layer 79 is formed either on the outer surface of the blade rotation shaft 52 or on the inner surface of the hub 54a, low friction coating such as fluorine resin coating or ceramic coating is preferably applied to the other surface. In this way, it is possible to further easily remove the unit of the grinding blade 54 and the cover 70. Since the low friction coating makes contact with not the exposed metallic surface but the heat insulation layer 79, abrasion and peeling are unlikely to be encountered, and thus it is possible to maintain low friction for a long period of time.

The control device 80 controls the rotation of the blade rotation shaft 52 as follows. Specifically, when the blade rotation shaft 52 is rotated by the kneading motor 60 or the grinding motor 64, before the rotation speed is increased to a set rotation speed (that is referred to as a “rated rotation speed” in the present specification) at the time of the kneading or grinding, the control device 80 rotates the blade rotation shaft 52 at a low speed or intermittently. The low speed rotation or the intermittent rotation is continuously performed for a predetermined period of time. FIG. 28 conceptually shows this relationship; in FIG. 28, three types of control methods (a), (b) and (c) are shown.

In the method (a), the blade rotation shaft 52 is continuously rotated at a low speed for a predetermined period of time, and then the rotation speed is increased to the rated rotation speed. When the blade rotation shaft 52 is rotated by the kneading motor 60 in the forward direction, since the first engagement member 76a of the clutch 76 is slowly moved to engage with the second engagement member 76b, the cover 70, the kneading blade 72, the complementary kneading blade 77 and the guard 78 are also moved slowly at an early stage, and thus the cereal grains, the liquid, the dough material that is the mixture of the ground cereal grains and the liquid and the like are not dispersed from the bread container 50. Noise and vibrations accompanied by the movement of the cover 70, the kneading blade 72, the complementary kneading blade 77 and the guard 78 at the early stage can be reduced to low levels. Mechanical components such as the clutch 76 are also prevented from being damaged.

The same is true for the rotation of the blade rotation shaft 52 in the opposite direction by the grinding motor 64; the blade rotation shaft 52 is continuously rotated at a low speed for a predetermined period of time, and then the rotation speed is increased to the rated rotation speed. While rotated at the low speed, the kneading blade 72 changes from the folded position to the open position and makes contact with the inner wall of the bread container 50, with the result that noise and vibrations at the time of the contact are reduced. It is possible to prevent the damage of the mechanical components due to the low-speed start period.

In the method (b), the rotation speed of the blade rotation shaft 52 is increased stepwise. The effects are the same as in the method (a).

In the method (c), the blade rotation shaft 52 is rotated intermittently, and is then continuously rotated. Even in this method, the cover 70, the kneading blade 72, the complementary kneading blade 77, the guard 78 and the grinding blade 54 can be gently moved at an early stage.

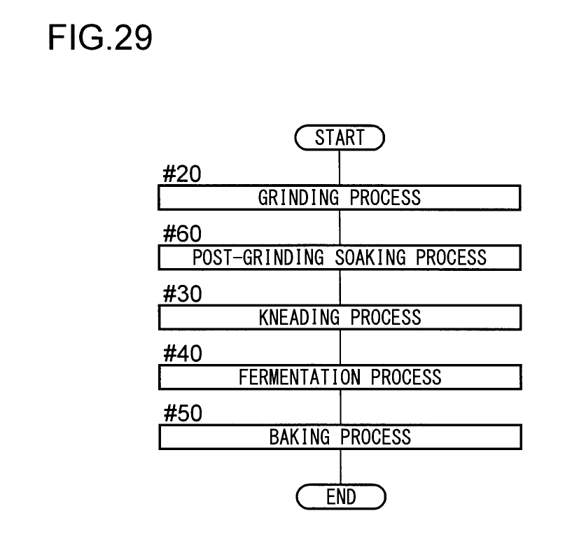

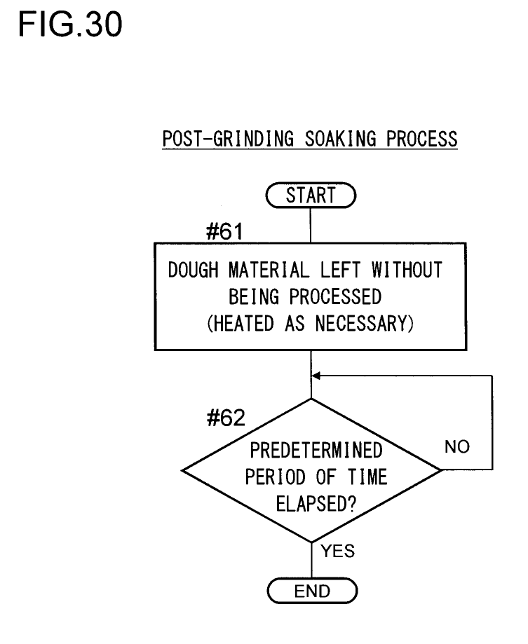

A second bread making process will now be described with reference to FIGS. 29 and 30. FIG. 29 is a flowchart of the entire second bread making process. As shown in FIG. 29, in the second bread making process, the process proceeds from the grinding process #20 to a post-grinding soaking process #60 to the kneading process #30 to the fermentation process #40 and to the baking process #50 in this order. The details of the post-grinding soaking process #60 will now be described with reference to FIG. 30.

In step #61, the dough material formed by the grinding process #20 is left within the bread container 50 without being processed. This dough material has not been subjected to the pre-grinding soaking process. While being left without being processed, the liquid soaks into the ground cereal grains. The control device 80 heats, by energizing the heating device 41 as necessary, the dough material to facilitate the soaking.

In step #62, the control device 80 checks how much time has elapsed since the start of the leaving of the dough material. When a predetermined period of time has elapsed, the post-grinding soaking process #60 is completed. After the completion of the post-grinding soaking process #60, the process automatically proceeds to the kneading process #30. The process after the kneading process #30 is the same as in the first bread making process.

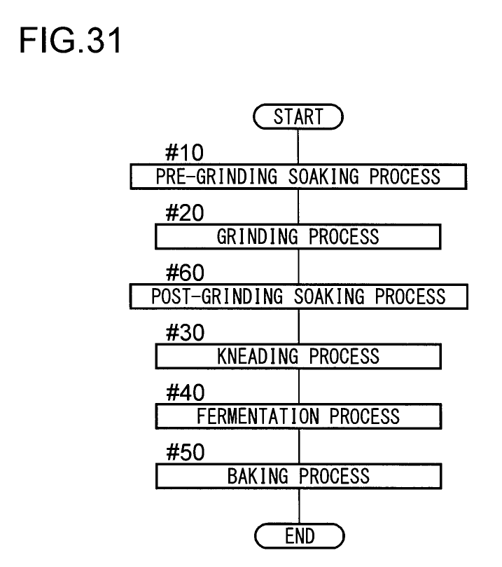

A third bread making process will now be described with reference to FIG. 31. FIG. 31 is a flowchart of the entire third bread making process. Here, before the grinding process #20, the pre-grinding soaking process #10 of the first bread making process is set; after the grinding process #20, the post-grinding soaking process #60 of the second bread making process is set. The process after the kneading process #30 is the same as in the first bread making process.

(The Others)

The grinding blade 54 described in the above embodiments is used not only for grinding the cereal grains but also for decreasing the size of optional ingredients such as nuts and leaf vegetables. Thus, it is possible to bake bread containing the optional ingredient of small grains. The grinding blade 54 is utilized for grinding food materials other than optional ingredients that are contained in bread and the materials of herbal medicines.

In the embodiments described above, since, with the single control device 80, the rotation of the grinding blade 54 and the rotation of the kneading blade 72 (and the complementary kneading blade 77) can be controlled such that they are associated with each other, it is possible to rotate the grinding blade 54 and the kneading blade 72 (and the complementary kneading blade 77) according to the type and the amount of cereal grains both at the stage where the cereal grains are ground and at the stage where the cereal powder after the grinding is kneaded, and thus to enhance the quality of the bread.

Although, in the embodiments described above, the grinding blade 54 for grinding the cereal grains is attached to the blade rotation shaft 52, and the cover 70 surrounding the grinding blade 54 serves as the support member for the kneading blade 72, in an automatic bread making machine that does not use the grinding blade, the kneading blade is attached directly to the blade rotation shaft. In this case, the heat insulation layer is preferably provided on one or both of surfaces of the blade rotation shaft and the blade rotation shaft reception portion of the kneading blade. The low friction coating is preferably applied to the surface on which the heat insulation layer is not formed.

Although the embodiments of the present invention have been described above, the scope of the present invention is not limited to the above description, and many modifications are possible without departing from the spirit of the present invention.

### INDUSTRIAL APPLICABILITY

The present invention can be widely applied to automatic bread making machines that are mainly used in common households.

### LIST OF REFERENCE SYMBOLS

1 Automatic bread making machine
10 Main body
40 Baking chamber
50 Bread container
52 Blade rotation shaft
54 Grinding blade
54a Hub (blade rotation shaft reception portion)
60 Kneading motor
64 Grinding motor
70 Cover
72 Kneading blade
76 Clutch
76a First engagement member
76b Second engagement member
79 Heat insulation layer
80 Control device

1. An automatic bread making machine comprising:
a bread container into which bread-making ingredients are put;
a baking chamber which is provided within a main body and which receives the bread container;
a blade rotation shaft which is provided in a bottom portion of the bread container;
a grinding blade which is attached to the blade rotation shaft such that the grinding blade cannot be rotated;
a dome-shaped cover which has a kneading blade on an outer surface and which is attached to the blade rotation shaft so as to cover the grinding blade;
a motor which is provided within the main body and which provides a rotation force to the blade rotation shaft; and
a clutch which switches whether to transmit the rotation force of the blade rotation shaft to the cover.

2. The automatic bread making machine of claim 1,
wherein the clutch intervenes between the blade rotation shaft and the cover, and the clutch couples, when the blade rotation shaft is rotated in one direction, the blade rotation shaft to the cover whereas the clutch disconnects, when the blade rotation shaft is rotated in an opposite direction from the one direction, the coupling between the blade rotation shaft and the cover.

3. The automatic bread making machine of claim 2,
wherein the kneading blade is attached to the cover such that a position of the kneading blade can be changed, and
the clutch switches the coupling state between the blade rotation shaft and the cover according to the position of the kneading blade.

4. The automatic bread making machine of claim 3,
wherein the kneading blade is provided on the cover such that the kneading blade can be rotated, and is attached to take two positions which are a folded position and an open position, and
when the blade rotation shaft is rotated in the one direction, the kneading blade is brought into the folded position and the clutch couples the blade rotation shaft to the cover whereas, when the blade rotation shaft is rotated in the opposite direction, the kneading blade is brought into the open position to make contact with an inner wall of the bread container and prevent the rotation of the cover, and the clutch disconnects the coupling between the blade rotation shaft and the cover.

5. The automatic bread making machine of claim 4,
wherein the clutch is formed with a first engagement member which is attached to the blade rotation shaft such that the first engagement member cannot be rotated and a second engagement member that is attached to a pivot shaft such that the second engagement member cannot be rotated, and the pivot shaft is arranged at a location away from the blade rotation shaft and moves together with the kneading blade, and
the second engagement member interferes, when the kneading blade is brought into the folded position, with a rotational orbit of the first engagement member whereas the second engagement member retracts, when the kneading blade is brought into the open position, from the rotational orbit of the first engagement member.

6. The automatic bread making machine of claim 1, further comprising:
a control device which controls the rotation of the blade rotation shaft,
wherein, at an early stage of the rotation of the blade rotation shaft, the control device rotates the blade rotation shaft either at a speed lower than a rated rotation speed or intermittently.

7. The automatic bread making machine of claim 6,
wherein the low speed rotation or the intermittent rotation is continued for a predetermined period of time.

8. The automatic bread making machine of claim 1,
wherein a heat insulation layer is provided on one or both of surfaces of the blade rotation shaft and a blade rotation shaft reception portion of the cover.

9. The automatic bread making machine of claim 1,
wherein a guard is removably attached to the cover such that the guard covers a bottom surface of the cover to prevent access of a finger to the grinding blade.

10. The automatic bread making machine of claim 9,
wherein the guard includes a hub that the blade rotation shaft passes through and a plurality of spokes in which spaces between the spokes are opening portions that cereal grains to be ground by the grinding blade pass through.

11. The automatic bread making machine of claim 10,
wherein the clutch intervenes between the blade rotation shaft and the cover, and the clutch couples, when the blade rotation shaft is rotated in the one direction, the blade rotation shaft to the cover whereas the clutch disconnects, when the blade rotation shaft is rotated in the opposite direction from the one direction, the coupling between the blade rotation shaft and the cover, and
the spokes are shaped such that, when the guard is rotated in the one direction, a side of a center of the guard moves ahead, and a side of an outer edge of the guard moves behind.

12. The automatic bread making machine of claim 10,
wherein, when the spokes of the guard are attached to the cover, the spokes are close to the grinding blade.

13. The automatic bread making machine of claim 1,
wherein the clutch intervenes between the blade rotation shaft and the cover, and the clutch couples, when the blade rotation shaft is rotated in the one direction, the blade rotation shaft to the cover whereas the clutch disconnects, when the blade rotation shaft is rotated in the opposite direction from the one direction, the coupling between the blade rotation shaft and the cover, and
a plurality of posts which surround the cover are formed on an outer edge of the guard such that the posts are arranged at a predetermined angle with respect to each other, and side surfaces of the posts that are front surfaces in a direction of rotation when the guard is rotated in the one direction are inclined upward.

14. The automatic bread making machine of claim 13,
wherein the guard includes a hub that the blade rotation shaft passes through and a plurality of spokes in which spaces between the spokes are opening portions that cereal grains to be ground by the grinding blade pass through, and
lower ends of the posts protrude downward beyond the spokes.

15. The automatic bread making machine of claim 13,
wherein the guard is attached by forming bayonet coupling between the posts and the cover, and a direction in which the guard is turned when the guard is attached coincides with the opposite direction of the rotation of the blade rotation shaft.
